(19) United States
(12) Patent Application Publication
(10) Pub. No.: US 2017/0214861 A1
(43) Pub. Date: Jul. 27, 2017

(54) RAPID AND PRECISE OPTICALLY MULTIPLEXED IMAGING

(71) Applicant: MASSACHUSETTS INSTITUTE OF TECHNOLOGY, CAMBRIDGE, MA (US)

(72) Inventors: Yaron Rachlin, Newton, MA (US); Tina Shih, Lexington, MA (US); Ralph Hamilton Shepard, Somerville, MA (US); Vinay N. Shah, Burlington, MA (US)

(21) Appl. No.: 15/162,023

(22) Filed: May 23, 2016

Related U.S. Application Data
(60) Provisional application No. 62/165,642, filed on May 22, 2015.

(51) Int. Cl. H04N 5/265; G02B 26/02; G02B 26/08; H04N 5/225; G02B 27/10

(52) U.S. Cl. CPC H04N 5/265; H04N 5/2259; G02B 27/1066; G02B 26/0816; G02B 26/023

(57) ABSTRACT

Described herein are devices and methods for uniquely encoding one or more channels of an optically multiplexed imaging system rapidly and precisely to improve the system's efficiency and performance. The disclosed devices and methods generally provide dynamically variable image encoding that can occur at speeds faster than a capturing frame rate of an image sensor and with a precision that is less than an angular sampling of an image sensor pixel. Such dynamically variable encoding can allow an imaging system to be optimized for use with various scene conditions and sensing objectives, while providing improved efficiency and robustness of disambiguation over prior technologies.

### CROSS-REFERENCE TO RELATED APPLICATIONS

This disclosure claims the benefit of U.S. Provisional Application No. 62/165,642, entitled “Rapid and Precise Optically Multiplexed Imaging,” and filed May 22, 2015. The entire contents of this application are incorporated by reference herein.

### GOVERNMENT RIGHTS

This disclosure was made with government support under Air Force contract FA8721-05-C-0002. The government has certain rights in the invention.

### FIELD

This disclosure relates generally to imaging and, more particularly, to optically multiplexed imaging of a field of view.

### BACKGROUND

Many different fields of endeavor have a need to image extended fields of view with high resolution to detect and observe objects within the field of view or track movement relative to reference points. For example, observational astronomy, celestial navigation systems, and security/surveillance applications all need to monitor extended fields of view with high resolution. Conventional imaging systems are limited by a tradeoff between field of view and resolution: with a finite number of pixels on an image sensor the sampling resolution in object space (i.e., the number of pixels devoted to a given area in the scene being imaged) is decreased as the field of view is increased. When requirements demand a combination of extended field of view and resolution that exceeds a conventional single-camera fixed field of view architecture, these needs are often met using arrays of multiple cameras or image sensors arranged to view different regions of a scene, or using a single sensor or pixel array with a scanning mechanism (e.g., a pan-tilt-zoom mechanism) to sweep out a high-resolution image of an extended field of view over time. The former is bulky and costly because it requires discrete optical and sensor assemblies for each region of the field of view. The latter suffers from the need for a scanning mechanism and intermittent temporal sampling (i.e., the device cannot view the entire field of view at any one time). Other designs incorporate both a bank of cameras and scanning mechanisms to improve upon some aspects of dedicated array or scanning devices, but these hybrid devices also suffer the disadvantages of both.

Other fields endeavor to create a stereo image or a 3-dimensional (3D) depth image of a scene. This can be done using two or more cameras that observe an object from different perspectives, or with a single camera that produces images from two or more perspectives on a single focal plane. The former method suffers from the added cost, power, volume, and complexity of using multiple cameras, as well as geometric and intensity differences in the images resulting from the different optical systems. Methods using a single camera approach typically either (a) use prisms or mirrors to produce two or more shifted images on a camera's focal plane where each image fills only a fraction of the focal plane's area to prevent overlap, thereby resulting in a reconstructed stereo image that has a smaller field of view and fewer pixels than are available in the image sensor, or (b) use a moving element that allows a sequence of frames to be captured from different perspectives. This latter approach is more complex and restricts the sampling rate of the system.

Optically multiplexed imaging is a developing field in the area of computational imaging. Images from different regions of a scene, or from different perspectives of the same region, are overlaid on a single sensor to form a multiplexed image in which each pixel on the focal plane simultaneously views multiple object points, or the same object point from multiple perspectives. Information bandwidth can be increased with optically multiplexed imaging because each pixel simultaneously views multiple object points. A combination of hardware and software processes are used to disambiguate the measured pixel intensities and produce a de-multiplexed image. The result can be a higher resolution and wider field of view image than is possible with conventional imaging systems that view only one object point with each image sensor pixel. For a system with N multiplexed channels, for example, the resulting image can have N-times greater pixels than the format of the image sensor used to capture the multiplexed image. This technique allows a multiplexed imaging device to increase its effective resolution (i.e. the number of pixels in the reconstructed image), which can then be applied to extending the field of view or capturing images from multiple perspectives without resolution loss.

Optically multiplexed imaging, then, can overcome fundamental tradeoffs and disadvantages associated with conventional imaging solutions, especially such solutions that implement image sensor arrays or scanning image sensors to observe large fields of view. Optically multiplexed imaging can, for example, deliver the high spatial and temporal resolution of a staring array of image sensors while requiring only a single optical telescope and focal plane image sensor array. This can save size, weight, power, and cost.

There are, however, challenges associated with optically multiplexed imaging. For example, optically multiplexed imaging can require significant computational resources to disambiguate the captured image and reconstruct de-multiplexed images therefrom. Inability to perform the required computations in a timely manner can prevent use of the system for, e.g., high frame rate video capture. By way of further example, prior techniques for optically multiplexed imaging can lack sufficient precision and/or speed to encode one or more multiplexed images in a manner that allows for efficient disambiguation. In some systems, for example, full-aperture beam splitters can be used to combine fields of view and a continuously scanning mirror can shift layers of the multiplexed image between frames to encode a single field of view. This technique can result in motion blur due to the continually scanning mirror and imprecise control of the encoding. In other multiplexed imaging systems, liquid crystal shutters are used to encode at least one image being multiplexed. Such a system also lacks dynamically variable sub-pixel precision that can allow for enhanced multiplexing performance. In still other systems, an array of interleaved micro-prisms and micro-eyelid shutters can be used to multiplex and encode multiple fields of view. While this can be a compact and efficient architecture, it can suffer from a limited spectral bandwidth due to chromatic aberrations caused by the prisms and it does not provide a capability for super-resolution or encoding with a spatial Point Spread Function, as described in more detail below.

Accordingly, there is a need for improved optically multiplexed imaging devices and methods. More particularly, there is a need for such devices and methods that can provide faster and more precise control of encoding elements to permit encoding in a manner that maximizes performance and efficiency of an optically multiplexed imaging system.

### SUMMARY

The present disclosure generally provides improved optically multiplexed imaging devices and methods through dynamically variable encoding of one or more image channels. In some embodiments, the dynamically variable image encoding can be any of rapid and precise, that is, occurring at frequencies at or above a capturing frame rate of an image sensor or array and with precision that is less than an angular sampling of an image sensor pixel. The devices and methods for dynamically variable image encoding described herein can be applied to a number of different optical design architectures and can provide a number of advantages over prior imaging systems or methods. For example, dynamically variable encoding of one or more channels in an optically multiplexed system can be utilized to provide flexibility for the optically multiplexed imaging system to operate in different modes optimized for specific scene conditions and sensing objectives. In addition, the devices and methods described herein can provide improved signal efficiency and robustness of disambiguation over prior imaging systems. This can enable, for example, efficient snapshot (i.e., single-frame) extended field of view disambiguation of sparse scenes. In addition, extended field of view imaging of a scene can be performed at rates adequate for motion video capture with the improved efficiency and performance of the devices and methods described herein.

The ability to dynamically encode one or more channels of an optically multiplexed imaging system at speeds at or above a capturing frame rate of an image sensor and with precision that is less than an angular sampling of an image sensor pixel can also provide a capability of recovering spatial resolutions finer than a pixel sampling. This can add a multiplicative factor to a resolution of an optically multiplexed imaging system, which already utilizes a single image sensor pixel to view multiple points in object space (i.e., in the scene being observed). The devices and methods described herein can also achieve temporal super-resolution due to the ability to rapidly and precisely vary encoding of one or more channels in the imaging device or system. More particularly, temporal information can be recovered at frequencies that exceed the image sensor or array frame rate.

Still another advantage provided by the devices and methods described herein is lower computational complexity during image reconstruction or disambiguation. More particularly, the computational architectures described herein can significantly lower complexity of image reconstruction when compared to conventional techniques for directly solving for an image through, for example, a matrix inversion process.

In one aspect, a method of imaging a scene is provided that includes capturing light from a plurality of regions of the scene in a plurality of channels, directing each of the plurality of channels onto a focal plane of an image sensor, and encoding an image formed by one or more of the plurality of channels prior to detection by the image sensor. Furthermore, the encoding of the image can be varied by a precise amount over time.

The devices and methods described herein can have a number of additional features and/or variations, all of which are within the scope of the present disclosure. In some embodiments, for example, in some embodiments encoding the image can include shifting the image. In such an embodiment, shifting the image can be performed with a precision that is less than an angular sampling of an image sensor pixel. In other embodiments, shifting the image can be performed at rates equal to, or faster than, a capturing frame rate of the image sensor.

Variations in encoding can be implemented in several manners. For example, in some embodiments a magnitude of image shift used to encode the image can be varied over time. Variations in the magnitude of image shift can occur at rates equal to, or greater than, a capturing frame rate of the image sensor. In other embodiments, a direction of image shift used to encode the image can be varied over time. Here again, variations in the direction of image shift can occur at rates equal to, or greater than, a capturing frame rate of the image sensor. In certain embodiments, a time delay between shifting the image can be varied over time.

A number of different imaging device architectures can be utilized to accomplish the teachings described herein. For example, in some embodiments shifting the image can be accomplished by tilting a mirror using an actuator. The actuator can, in certain embodiments, be a piezoelectric actuator that can be precisely controlled and capable of adjusting the tilt of a mirror rapidly.

In other embodiments, encoding the image can include applying an engineered point spread function instead of shifting an image, and a spatial structure of the engineered point spread function can be varied over time.

Still another method for encoding the image can include at least partially attenuating the image, and any of a duration and an extent of the at least partial attenuation can be varied over time. Encoding via attenuation can be implemented in a variety of manners. In some embodiments, attenuating the image can include placing a partially transparent attenuator in a light path of the channel being encoded. In other embodiments, attenuating the image can include placing a fully absorbing attenuator in a light path of the channel being encoded. In certain embodiments, attenuating the image can include rotating an attenuating element about an axis to place different regions of its area into a light path of the channel being encoded. The different regions of the attenuator can be fully absorbing or partially transparent.

Another method for encoding the image can include imparting illumination to the channel being encoded to amplify a signal thereof relative to other channels.

In certain embodiments, encoding the image can include modifying a phase of the image by imparting any of an aberration and a diffraction effect into a wavefront moving through the channel being encoded. Modifying the phase of the image can include placing a wedged optical element into a light path of the channel being encoded in some embodiments. In other embodiments, modifying the phase of the image can include placing a non-plano surface into a light path of the channel being encoded.

In order to maintain a compact size, imaging devices according to the teachings provided herein can make use of miniaturized components that provide rapid and precise positioning capabilities. For example, in some embodiments encoding the image can be performed using a micro-electromechanical system (MEMS) light modulating array. The MEMS array can be, in some embodiments, an array of mirrors that can be rapidly and precisely tilted or translated to a variety of positions. In other embodiments, encoding the image can include deforming a mirror to alter characteristics of an image being reflected thereby.

While a variety of different techniques for encoding an image are disclosed above, in some embodiments the image formed by one or more of the plurality of channels can be encoded using at least two different techniques in combination with one another. For example, in some embodiments the at least two different techniques can include modifying a phase of the image and attenuating the image. Furthermore, modifying the phase of the image can include any of shifting the image and applying an engineered point spread function to the image.

In another aspect, a method of imaging a scene is provided that includes capturing light from a plurality of regions of the scene in a plurality of channels, directing each of the plurality of channels onto a focal plane of an image sensor, and capturing a frame from the image sensor containing all of the images formed by the plurality of channels in a first state. The method can further include modifying an image formed by at least one of the plurality of channels to a second state, as well as capturing a frame from the image sensor containing all of the images formed by the plurality of channels in the second state. The method can also include repeating the steps of modifying an image formed by at least one of the plurality of channels and capturing a frame from the image sensor for each of a plurality of predetermined states.

Any number of predetermined states can be employed, and in some embodiments the method can further include repeatedly cycling through the plurality of predetermined states. Further, the plurality of predetermined states can follow a predetermined pattern. In other embodiments, the plurality of predetermined states can be any of random and non-repeating. In some embodiments, the plurality of predetermined states can include two states and an image formed by at least one of the plurality of channels can oscillate between the two states in time with a capturing frame rate of the image sensor.

In certain embodiments, modifying the image can include shifting the image by a magnitude equal to, or greater than, one pixel at the focal plane. Moreover, in some embodiments shifting the image can occur at a rate equal to, or greater than, a capturing frame rate of the image sensor. In other embodiments, modifying the image can include at least partially attenuating the image. In still other embodiments, modifying the image can include applying an engineered point spread function to the image.

In another aspect, a method of imaging a scene is provided that includes capturing light from a plurality of regions of the scene in a plurality of channels and directing each of the plurality of channels onto a focal plane of an image sensor. The method can further include encoding an image formed by one or more of the plurality of channels prior to capture by the image sensor, and decoding the image formed by one or more of the plurality of channels using an algorithm paired to the encoding method. Such a method can select encoding and decoding methods in connection with one another to provide advantages, such as less computationally intensive disambiguation, disambiguation with fewer frame captures, disambiguation with lower noise levels, etc.

As with the methods described above, a number of variations and additional features are possible. For example, in some embodiments encoding the image can include spatially shifting the image. The magnitude of the shift can vary and, in some embodiments, the image can be spatially shifted by an integer amount of pixels. Moreover, the timing of the shifts can be adjusted. In some embodiments, for example, the image can be spatially shifted per frame captured by the image sensor. In such an embodiment, decoding the image can include taking differences between sequential frames to yield a spatial derivative of the image along a direction of motion.

In other embodiments, encoding the image can include attenuating one of the plurality of channels per frame captured by the image sensor. In still other embodiments, encoding the image can include spatially shifting an image formed by each of the plurality of channels using a predetermined unique frequency, and decoding the image can include conducting a frequency analysis of a time series for each pixel of the image sensor.

A similar encoding strategy can be employed utilizing any of the other encoding methods described herein. For example, in some embodiments encoding the image can include any of defocusing and point spread function encoding an image formed by each of the plurality of channels using a predetermined unique frequency, and decoding the image can include conducting a frequency analysis of a time series for each pixel in the image sensor.

In other embodiments, encoding the image can include attenuating an image formed by each of the plurality of channels using a predetermined function of time such that the image can be measured using a matrix with positive, bounded entries, and decoding the image can include measuring a time series for each pixel of the image sensor and constructing the image with a matrix inverse. The predetermined function of time can any of activate and deactivate each of the plurality of channels at a unique frequency, and decoding the image can include computationally projecting the time series of each pixel of the image sensor onto a corresponding channel frequency. In some embodiments, the matrix inverse can be performed within logic of each pixel of the image sensor. Still further, in some embodiments performing the matrix inverse can include projecting measured light onto rows of an inverse matrix using logic that implements a dot product.

In other embodiments, attenuating an image formed by each of the plurality of channels can include reflecting light off a light modulating array and measuring a distinct time series per pixel at two different focal planes, wherein each time series corresponds to two directions light could be reflected from the array. In such an embodiment, decoding the image can include taking a difference between the time series in order to instantiate a matrix with bounded entries that are any of negative and positive. And the method can further include computationally inverting the matrix with bounded entries to recover the image formed by one of the plurality of channels. As noted above, the light modulating array can, in some embodiments, be a micro-electromechanical (MEMS) mirror array.

In certain embodiments, encoding the image can include spatially shifting all but one of the plurality of channels during a single integration period to blur images created by all but one of the plurality of channels. In such an embodiment, decoding the image can include removing the one channel not spatially shifted from the blurred background of the other channels.

Alternatively, encoding the image can include continuously shifting each of the plurality of channels along different trajectories. In such an embodiment, decoding the image can include shifting any of a charge and a digital measurement of the image sensor to follow a trajectory of the channel being decoded, thereby allowing the image to be removed from a blurred background of other channels. In some embodiments, the method can further include simultaneously decoding images formed by a plurality of channels by simultaneously shifting any of a charge and a digital measurement of the image sensor along a plurality of trajectories used to shift images formed by the plurality of channels.

In other embodiments, encoding the image can include differentially rotating each of the plurality of channels so that an image formed by each channel moves in a different direction on the focal plane of the image sensor. In such an embodiment, decoding the image can include shifting any of a charge and a digital measurement of the image sensor to follow a direction of the channel being decoded, thereby allowing the image to be removed from a blurred background of other channels. In some embodiments, the method can further include simultaneously decoding images from a plurality of channels by simultaneously shifting any of a charge and a digital measurement of the image sensor along a plurality of directions used to rotate images formed by the plurality of channels.

In another aspect, a method of imaging a scene is provided that includes capturing light from a plurality of regions of the scene in a plurality of channels and directing each of the plurality of channels onto a focal plane of an image sensor simultaneously. The method can also include encoding one or more of the plurality of channels in a first mode that permits disambiguation of an image formed by each of the plurality of channels from a single frame capture of the image sensor.

In some embodiments, the scene can be sparse in at least one dimension. This can reduce the number of observed items that change in the image over time. As with the above-described methods, encoding can be accomplished in a variety of manners. In some embodiments, for example, encoding one or more of the plurality of channels in a first mode can include applying an engineered point spread function to the channel being encoded.

In certain embodiments, the method can further include encoding one or more of the plurality of channels in a second mode that permits disambiguation of an image formed by each of the plurality of channels using a plurality of single frame captures of the image sensor. For example, encoding one or more of the plurality of channels in a second mode can include shifting and settling images formed by one or more of the plurality of channels with a precision that is less than an angular sampling of an image sensor pixel and at a rate equal to, or greater than, a capturing frame rate of the image sensor. Or, in other embodiments encoding one or more of the plurality of channels in a second mode can include at least partially attenuating images formed by one or more of the plurality of channels.

The method can include switching between encoding in the first mode and encoding in the second mode in some embodiments. For example, an imaging system adapted for surveillance might operate in a first mode during a “standby” period during which a relatively sparse, or unchanging, scene is observed. Upon detection of activity, however, the system can switch to operating in the second mode to process a more information-rich, or dense, scene. In some embodiments, switching between encoding in the first mode and encoding in the second mode can occur at a predetermined rate slower than a capturing frame rate of the image sensor. As noted above, in some embodiments switching between encoding in the first mode and encoding in the second mode can occur in response to information detected in the scene being imaged. In other embodiments, however, switching between encoding in the first mode and encoding in the second mode can occur in response to receiving a command, such as a command from a user or other system managing an imaging system.

In another aspect, a method of imaging a scene can include capturing light from a plurality of regions of the scene in a plurality of channels and directing each of the plurality of channels onto a focal plane of an image sensor. The method can further include constructing an image of the scene at a resolution higher than a native resolution of the image sensor by shifting and settling images formed by the plurality of channels with precision that is less than an angular sampling of an image sensor pixel. In some embodiments, shifting and settling of images formed by the plurality of channels can occur at rates equal to, or faster than, a capturing frame rate of the image sensor.

In another aspect, an imaging device can include an image sensor and a multiplexing assembly configured to collect light from a plurality of regions of a scene into a plurality of channels and direct each channel to the image sensor. Moreover, the multiplexing assembly can be configured to encode an image formed by one or more of the plurality of channels in a manner that varies over time by a precise amount.

As with the methods described above, a number of variations and additional features can be included in the imaging device. For example, in some embodiments encoding an image formed by one or more of the plurality of channels can include shifting the image with a precision that is less than an angular sampling of an image sensor pixel at a rate that is equal to, or faster than, a capturing frame rate of the image sensor. In other embodiments, encoding an image formed by one or more of the plurality of channels can include applying an engineered point spread function, and a spatial structure of the engineered point spread function can be varied over time.

Other encoding methods are also possible and, in certain embodiments, encoding an image formed by one or more of the plurality of channels can include at least partially attenuating the image, and any of a duration and an extent of the at least partial attenuation can be varied over time. In still other embodiments, encoding an image formed by one or more of the plurality of channels can include modifying a phase of the image by imparting any of an aberration and a diffraction effect into a wavefront moving through the channel being encoded. As noted above, any of the various encoding techniques described herein can be used in isolation, or can be combined with one another such that, in some embodiments, encoding an image formed by one or more of the plurality of channels can include encoding with at least two different techniques. The at least two different techniques can include, for example, modifying a phase of the image and attenuating the image. Further, modifying the phase of the image can include any of shifting the image and applying an engineered point spread function to the image.

The imaging device can have a variety of additional components. For example, in some embodiments the multiplexing assembly can include a mirror coupled to an actuator configured to tilt the mirror. Any of a variety of actuators can be utilized and, in some embodiments, the actuator can be piezoelectric. In other embodiments, the multiplexing assembly can include a deformable mirror. In still other embodiments, the multiplexing assembly can include a deformable mirror.

In certain embodiments, the multiplexing assembly can include other light modulating components. For example, in some embodiments the multiplexing assembly can include a micro-electromechanical system (MEMS) light modulating array. This can, in some embodiments, include a MEMS mirror array. In other embodiments, the multiplexing assembly can include an attenuator configured to at least partially block light from one or more of the plurality of channels before it reaches the image sensor. The attenuator can be partially transparent in some embodiments, and can be fully absorbing in other embodiments. The attenuator can be configured to rotate about an axis to place different regions of its area into a light beam path of one or more of the plurality of channels.

In still other embodiments, the multiplexing assembly can include a source of illumination configured to amplify light from one or more of the plurality of channels before it reaches the image sensor. In some embodiments, the multiplexing assembly can include still other components, such as a phase encoding element. The phase encoding element can be any of transparent and reflective. For example, in some embodiments, the phase encoding element can be a wedge-shaped optical element that moves to shift an image formed by one of the plurality of channels. In other embodiments, the phase encoding element can be a non-plano surface that encodes a point spread function of an image formed by one of the plurality of channels by imparting any of an aberration and a diffraction effect into a light wavefront.

The multiplexing assembly can be configured to direct light in a variety of different manners. For example, the multiplexing assembly can simultaneously direct light from each of the plurality of channels onto the image sensor such that light from each channel forms an image on the sensor that fills a focal plane of the image sensor and overlaps with images formed by other channels.

A number of other optical elements can also be included in the imaging device. For example, in some embodiments the multiplexing assembly can be positioned between an optical element and an image plane of the device. In other embodiments, the device can further include a narcissus shield configured to any of partially and fully attenuate light passed therethrough. Moreover, the image sensor can be configured to detect infrared (IR) light and the narcissus shield can be positioned in combination with the multiplexing assembly near an aperture stop of the imaging device in front of at least one optical element. The above-mentioned narcissus shield can, in some embodiments, be configured to any of rotate and translate. In certain embodiments, the imaging device can further include a baffle configured to block stray light from joining light in at least one of the plurality of channels.

A variety of image sensors can be utilized with the imaging device. For example, in some embodiments the image sensor can be configured to detect any of ultraviolet (UV), visible, and infrared (IR) light.

In other embodiments, the imaging device can further include an imaging lens having a fixed effective focal length. Embodiments in which the imaging device further includes an imaging lens having a variable effective focal length are also contemplated. The imaging lens of the imaging device can, in some embodiments, include a plurality of discrete focal lengths. In other embodiments, the imaging lens can include a focal length that is continuously variable over a range of values. Variation of the focal length of the imaging lens can, in some embodiments, cause a projection of a center of the region imaged by each of the plurality of channels to remain fixed relative to the scene. In other embodiments, variation of the focal length of the imaging lens can cause a projection of a center of the region imaged by each of the plurality of channels to shift relative to the scene. In certain embodiments, one or more elements of the multiplexing assembly can be configured to be any of actively steered and phase controlled to move a projection of a center of the region imaged by each of the plurality of channels as the effective focal length is varied.

In other embodiments, the imaging lens can include a variable focal length afocal objective zoom lens configured to direct light into the multiplexing assembly. In some embodiments, the imaging lens can include a variable focal length object zoom lens and the multiplexing assembly can have a fixed focal length. The variable focal length objective zoom lens can be configured to form an intermediate image that is reimaged with the fixed focal length multiplexing assembly.

Moreover, the regions of the scene observed by the imaging device can be arranged in a variety of overlapping and non-overlapping configurations. For example, in some embodiments the plurality of regions of the scene can overlap one another. In addition, the plurality of regions of the scene can be observed from different perspectives. Further, the plurality of regions of the scene can partially overlap one another in some embodiments, and completely overlap with one another in other embodiments. In still other embodiments, the plurality of regions of the scene can be separated from one another.

Other arrangements are also possible. For example, in some embodiments the plurality of regions of the scene can be adjacent to one another. In other embodiments, the plurality of regions of the scene can be arranged to create a panoramic image of the scene.

Any of the features or variations described above can be applied to any particular aspect or embodiment of the disclosure in a number of different combinations. The absence of explicit recitation of any particular combination is due solely to the avoidance of repetition in this summary.

### BRIEF DESCRIPTION OF THE DRAWINGS

FIG. 1 is a schematic illustration of one embodiment of an imaging device with multiplexing capability;

FIG. 2 is a schematic illustration of one embodiment of an imaging device including a movable reflective element as an encoding element;

FIG. 3 is a schematic illustration of one embodiment of an imaging device including a fixed reflective element and an encoding element;

FIG. 4 is a schematic illustration of one embodiment of an imaging device including a movable reflective element and a pupil dividing multiplexing element;

FIG. 5 is a schematic illustration of one embodiment of an imaging device including a fixed reflective element, a pupil dividing multiplexing element, and an encoding element;

FIG. 6 is a schematic illustration of one embodiment of an imaging device including a prism-based pupil dividing multiplexing element and an encoding element;

FIG. 7 is a schematic illustration of one embodiment of an imaging device including an encoding element utilizing a light source;

FIG. 8 is a schematic illustration of one embodiment of an imaging device including a plurality of movable reflective elements for multiplexing fields of view;

FIG. 9 is a schematic illustration of one embodiment of an imaging device including a plurality of fixed reflective elements and an encoding element for multiplexing fields of view;

FIG. 10 is a schematic illustration of one embodiment of an imaging device including a finite-conjugate multiplexed lens;

FIG. 11 is a schematic illustration of one embodiment of an imaging device including a reverse-telephoto lens with an encoding element positioned at a remote aperture stop;

FIG. 12 is a schematic illustration of one embodiment of an imaging device including a telephoto lens with an encoding element positioned at a remote aperture stop;

FIG. 13 is a schematic illustration of one embodiment of an imaging device including a multiplexed zoom lens;

FIG. 14 is a schematic illustration of an alternative embodiment of an imaging device including a multiplexed zoom lens;

FIG. 15 is schematic illustration of one embodiment of an imaging device including a zoom objective lens and a finite-conjugate multiplexing relay lens;

FIG. 16 is a schematic illustration of one embodiment of an imaging device including a Petzval lens design with an encoding element at a remote aperture stop;

FIG. 17A is a schematic illustration of one embodiment of an imaging device including a Petzval lens design and a 4-channel achromatic prism multiplexing assembly;

FIG. 17B is an alternative view schematic illustration of the imaging device of FIG. 17A;

FIG. 18 is a schematic illustration of one embodiment of an imaging device including movable reflective elements and an encoding element;

FIG. 19 is a schematic illustration of one embodiment of an imaging device including a multiplexing assembly having a plurality of movable reflective elements;

FIG. 20 is a schematic illustration of one embodiment of an imaging device including a reimaging pupil relay lens design and movable reflective elements;

FIG. 21 is a schematic illustration of one embodiment of an imaging device including reimaging pupil relay lens design, fixed reflective elements, and an encoding element;

FIG. 22 is a schematic illustration of one embodiment of an imaging device including a narcissus shield and a pupil dividing multiplexing assembly;

FIG. 23 is a schematic illustration of one embodiment of an imaging device including a reflective telescope design, encoding element, and pupil dividing prisms;

FIG. 24 is a front illustration of one embodiment of an imaging device including a reflective telescope design and movable reflective elements for encoding one or more fields of view;

FIG. 25 is a front illustration of one embodiment of an imaging device including a three-mirror telescope design that relays an internal stop to the multiplexing assembly, as well as an encoding element;

FIG. 26 is a schematic illustration of one embodiment of an imaging device including a three-mirror telescope design that relays an internal stop to the multiplexing assembly, as well as movable reflective elements for encoding one or more fields of view; and

FIG. 27 is a schematic illustration of another embodiment of an imaging device including a three-mirror telescope design that relays an internal stop to the multiplexing assembly, as well as movable reflective elements for encoding one or more fields of view.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present application. Further, in the present disclosure, like-numbered components of the embodiments generally have similar features, and thus within a particular embodiment each feature of each like-numbered component is not necessarily fully elaborated upon. To the extent features are described herein as being a “first feature” or a “second feature,” such numerical ordering is generally arbitrary, and thus such numbering can be interchangeable.

As noted above, optically multiplexed imaging is a developing field in the area of computational imaging that involves overlaying multiple images from different regions of a scene onto a single focal plane array or image sensor to form a multiplexed image. A combination of hardware and software processes can be used to disambiguate, or separate and reconstruct, the multiple de-multiplexed images. Optically multiplexed imaging can provide unique advantages over conventional imaging technologies. For example, optically multiplexed imaging systems can create higher resolution and wider field of view images than is possible with conventional imaging technologies because various fields of view are overlaid on one another at full resolution. Further, optically multiplexed imaging systems can be smaller, more efficient, and cheaper than conventional imaging systems of comparable capability because they can utilize a single optical system and focal plane image sensor or array where a conventional imaging system would require multiple sensors or arrays, along with attendant optical elements.

The Applicants of the present disclosure previously disclosed novel devices and methods for optically multiplexed imaging in U.S. patent application Ser. No. 14/668,214 (Atty. Dkt. No. 101328-347), entitled “Devices and Methods for Optically Multiplexed Imaging,” filed Mar. 25, 2015, the entire contents of which are incorporated by reference herein. In one embodiment disclosed therein, an optically multiplexed imaging device included a faceted reflective multiplexing assembly that divides the pupil area of an optical system into a plurality of sub-pupil contiguous multiplexed regions. Each sub-pupil region of the imaging optical system, referred to as channels, could be uniquely encoded to aid in disambiguation.

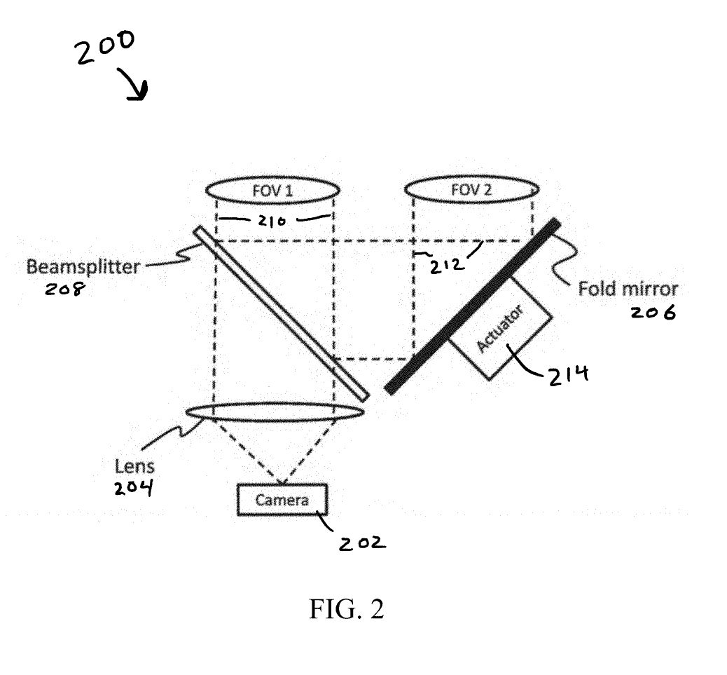

The teachings of the present disclosure improve the previously-described devices and methods by encoding one or more channels of an optically multiplexed imaging device or system in a manner that is dynamic, or variable over time. Moreover, in certain embodiments the devices and methods described herein can provide dynamically variable image encoding that is both rapid and precise to enable improved performance of the imaging devices and systems described herein. In some embodiments, rapid can mean variation at frequencies at or above a capturing frame rate of an image sensor or array, and precise can mean movement with precision that is less than an angular sampling of an image sensor pixel. The devices and methods for dynamically variable image encoding described herein can be applied to a number of different optical design architectures, as shown in FIGS. 2-27. The architectures illustrated in these figures are not an exhaustive listing, however, and other possible variations or applications of the teachings provided herein are considered within the scope of the disclosure.

The devices and methods described herein can provide a number of advantages over prior imaging systems or methods. For example, dynamically variable encoding of one or more channels in an optically multiplexed system can be utilized to provide flexibility for the optically multiplexed imaging system to operate in different modes optimized for specific scene conditions and sensing objectives. By way of further example, an optically multiplexed imaging system can be configured to switch between operating in a first mode that can be suitable for capturing and efficiently disambiguating a sparse scene (i.e., a scene in which objects of interest are sparsely distributed in at least one dimension, such as time or space) and a second mode that can be suitable for capturing and efficiently disambiguating a rich scene (i.e., a more information-rich scene or one in which objects of interest are more numerous and/or closely grouped in at least one dimension). The ability to dynamically switch between operating modes can increase the efficiency of the imaging system and can find particular utility, for example, in surveillance imaging applications (e.g., the first mode can be utilized to view a scene until, for example, activity is detected, whereupon the system can switch to the second mode).

The devices and methods described herein can provide a further advantage of improved signal efficiency and robustness of disambiguation over prior imaging systems. This can enable, for example, efficient snapshot (i.e., single-frame) extended field of view disambiguation of sparse scenes. In addition, extended field of view imaging of a scene can be performed at rates adequate for motion video capture with the improved efficiency and performance of the devices and methods described herein.

The ability to dynamically encode one or more channels of an optically multiplexed imaging system at speeds at or above a capturing frame rate of an image sensor and with precision that is less than an angular sampling of an image sensor pixel can provide a number of advantages, such as the capability of recovering spatial resolutions finer than a pixel sampling. This can add a multiplicative factor to a resolution of an optically multiplexed imaging system, which already utilizes a single image sensor pixel to view multiple points in object space (i.e., in the scene being observed). The devices and methods described herein can also achieve temporal super-resolution due to the ability to rapidly and precisely vary encoding of one or more channels in the imaging device or system. More particularly, temporal information can be recovered at frequencies that exceed the image sensor or array frame rate.

Yet another example of advantages provided by the devices and methods described herein is lower computational complexity during image reconstruction or disambiguation. More particularly, the computational architectures described herein can significantly lower complexity of image reconstruction when compared to conventional techniques for directly solving for an image through, for example, a matrix inversion process. This can be accomplished in some embodiments by utilizing a decoding or disambiguation algorithm that is paired to the method of encoding used during multiplexed imaging. That is, encoding and decoding methods can be paired to provide advantages, such as less computationally intensive disambiguation, faster disambiguation, etc.

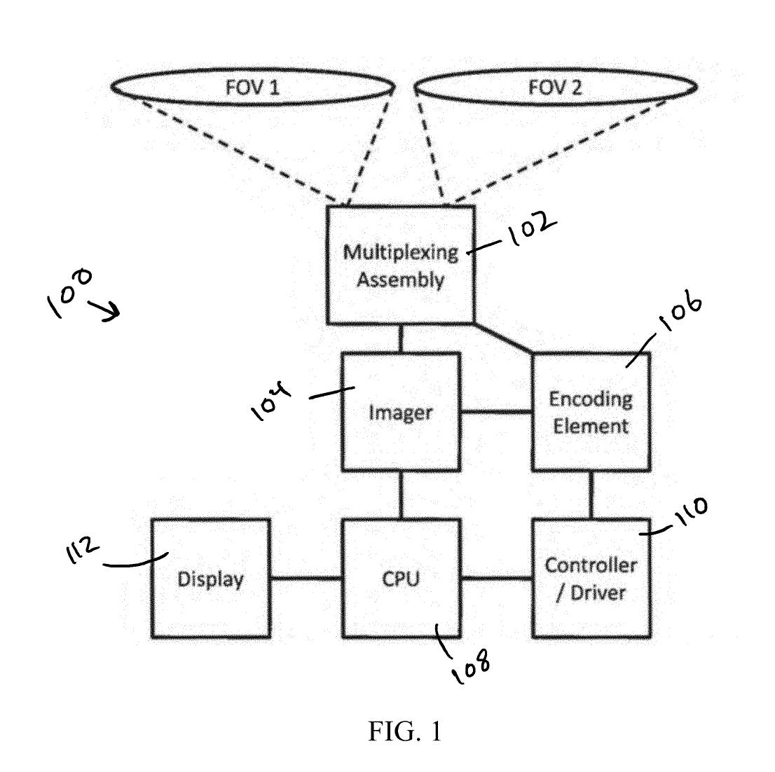

Turning to FIG. 1, an optically multiplexed imaging system 100 is shown schematically. The system 100 includes a multiplexing assembly 102 that captures light from a plurality of regions of a scene (two such regions are shown in the figure as FOV 1 and FOV2, though any number of regions are possible) and directs the light into an imager 104. The light from each region of the scene referred to as a channel. The imager 104 can include any number of optical elements, such as an imaging lens, and an image sensor or array of sensors. In addition, the system 100 includes one or more encoding elements 106 configured to act on one or more of the channels. Light is focused on the image sensor or array by the lens (or lenses) and signals are processed by a digital data processor 108 (e.g., a central processing unit or CPU) coupled thereto. The digital data processor 108 can communicate with a controller/driver 110 that can synchronize movement and/or other actuation of the encoding elements 106 with the image sensor or array. Thus, the encoding elements encode the plurality of multiplexed channels in a known manner. Using this known encoding, the digital data processor 108 can process an image or series of images to disambiguate the regions of the scene being observed (e.g., FOV 1 and FOV 2). A de-multiplexed reconstructed image can be presented to a user on a display 112 and/or stored in a digital data store for later viewing, analysis, etc.

Note that the various fields of view FOV 1 and FOV 2 shown in FIG. 1 and throughout the remainder of the figures in the present disclosure can have a variety of relative positions in object space (i.e., in the scene being observed). In some embodiments, for example, the fields of view or regions of the scene can be separated from one another. In other embodiments, the fields of view can be separate from one another but adjacent to, or contiguous with, one another. In still other embodiments, the fields of view can be at least partially overlapping and, in some embodiments, the fields of view can be completely overlapping. Overlapping fields of view can be useful for certain disambiguation algorithms and can be necessary for 3-dimensional imaging. In addition, in some embodiments overlapping fields of view can be captured from different perspectives to aid in 3-dimensional image creation.

The devices and methods described herein relate to encoding one or more of the channels in a dynamically variable manner using the one or more encoding elements 106. The concept is to encode one or more of the channels—and in some embodiments all of the channels—in a manner that is unique to each channel and dynamic (i.e., variable in time). In some embodiments, such encoding can also be performed rapidly (i.e., at frequencies at or above a capturing frame rate of the image sensor or array of the imager 104) and/or precisely (i.e., in a spatial context movement with a precision that is less than an angular sampling of an image sensor pixel).

Generally speaking, encoding according to the teachings provided herein can include applying a complex function to an electric field of incoming light. A complex function, as used herein, encompasses encoding that can modify the intensity, phase, and/or wavelength of the electric field. By way of example, intensity modulation can be achieved with an attenuating elements such as a physical or electro-optical shutter. Intensity modulation can also be accomplished using any number of spatial light modulating technologies, including, but not limited to, mechanical shutters (e.g., either fully attenuating/absorbing or partially transparent), micro-electromechanical systems (MEMS) such as digital micro-mirror devices (DMDs), eyelid arrays, or other MEMS light modulating arrays, as well as multiple liquid crystal-based technologies. Phase modulation can be achieved by physically or electro-optically changing the phase of light traversing the multiplexing assembly. This can include, for example, physically deforming or moving an optical surface using, e.g., a deformable mirror, a motion controller (e.g., a piezoelectric or other type of actuator), a MEMS device, or by rapidly inserting and removing an optical element encoded with a particular phase profile, such as a tilt to shift the image or a more complex aberration to spatially encode the point spread function ( ). Non-mechanical phase modification is also possible using, for example, a liquid crystal phase modulator. Wavelength encoding of the electric field can be accomplished by way of spectral filters, gratings, prisms, and/or other chromatically dispersive optical media.

FIGS. 2-27 illustrate various embodiments of optically multiplexed imaging devices according to the teachings of the present disclosure. Of course, these embodiments do not represent an exhaustive listing and a number of other embodiments are possible without departing from the scope of the teachings provided herein. The embodiment of FIG. 2, for example, illustrates an optically multiplexed imaging system 200 including a camera 202 with an image sensor or array and an optical system notionally illustrated by a lens 204. Lens 204, however, could be any number of lenses, mirrors, and/or other optical elements.

The system 200 multiplexes images of FOV 1 and FOV 2 using one or more fold mirrors 206 and one or more beam splitters 208, as shown by light paths 210 and 212, respectively. Moreover, the fold mirror 206 can be coupled to an actuator 214 to tip, tilt, or otherwise move the fold mirror. The actuator 214 can be activated by a motor, piezoelectric mechanism, or any other known mechanism. Importantly, the actuator 214 can be capable of moving the fold mirror 206 rapidly and precisely, as described above. For example, in one embodiment the actuator 214 (or actuators) can rapidly tilt and settle the fold mirror 206 (or mirrors) by a known angle between frames to laterally shift one or more channels (i.e., images of FOV 1, FOV 2, etc.) of the multiplexed image. Encoding in this manner can require that the actuator 214 be capable of completing such a shift in the time between consecutive frame captures by the camera 202. Further, in some embodiments super-resolution imaging can be achieved with this method of encoding by precisely controlling the fold mirrors to sample multiple angles within the field of view of a single pixel. Accordingly, encoding in this manner can also require the actuator 214 be capable of tilting or otherwise moving the fold mirror 206 with a precision that is less than an angular sampling of a pixel in the image sensor or array of the camera 202. In an alternative embodiment, the actuator 214 can be configured to rapidly tilt the fold mirror 206 at a frequency faster than the frame rate of the camera 202 to spatially encode the point spread function by motion blur.

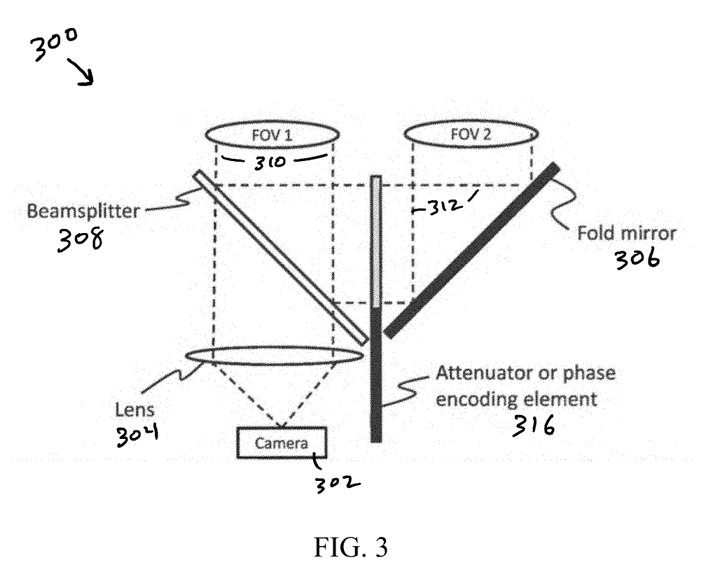

FIG. 3 illustrates an alternative embodiment of an optically multiplexed imaging system 300 that is similar to the system 200 of FIG. 2, but employs a different type of encoding element. In the system 300, a fold mirror 306 is stationary rather than mounted to an actuator that can rapidly and precisely shift its position. Rather, an encoding element 316 is placed in a light path 312 of the channel imaging FOV 2. The encoding element 314 can be, for example, an attenuator or phase encoding element that can, for example, encode the point spread function of the image or laterally shift the image. In some embodiments, the encoding element 316 can be configured to move relative to the fold mirror 306 so as to dynamically vary encoding of an image of FOV 2. For example, the phase encoding element or attenuator can be configured to rotate about an axis at a known frequency related to a frame rate of the camera 302 to periodically attenuate or phase encode a channel. Rotation can be continuous in some embodiments, or can the encoding element 316 can be configured to stop and settle between sampled frames. In still another embodiment, the encoding element 316 can be configured to rapidly translate between two or more positions that place different regions of its area in the path of one or more channels.

Moreover, encoding of the multiplexed channel images by rapid and precise movements of the fold mirror 206 or encoding element 314 can be varied over time. Variation can be spatial in nature, such as variation in the magnitude and/or direction of image shifting or the spatial structure of an engineered point spread function, or they can be temporal in nature, such as variation in the time delay between applying image shifts to one or more channels or the duration of applying attenuation to one or more channels. Such variation can occur at rates up to or exceeding the capturing frame rate of the system camera/image sensor or other detector.

While the embodiments shown in FIGS. 2-3 include a single type of encoding element, e.g., a tiltable or otherwise movable fold mirror with actuator, an attenuator, or a phase encoding element, in some embodiments more than one type of encoding element can be utilized. For example, in some embodiments an optically multiplexed imaging system can include one or more tiltable or otherwise movable fold mirrors coupled to one or more actuators, as well as an attenuator or other phase encoder. Any of a number of different combinations can be employed, and the inclusion of multiple encoding elements can, in some embodiments, provide even greater efficiency and/or performance gains when disambiguating a multiplexed image. For example, including multiple encoding elements (including, e.g., multiple types of encoding elements) can provide flexibility in the disambiguation process, which can permit use of various disambiguation methods that can produce de-multiplexed images any of faster, better, using less computational resources, etc.

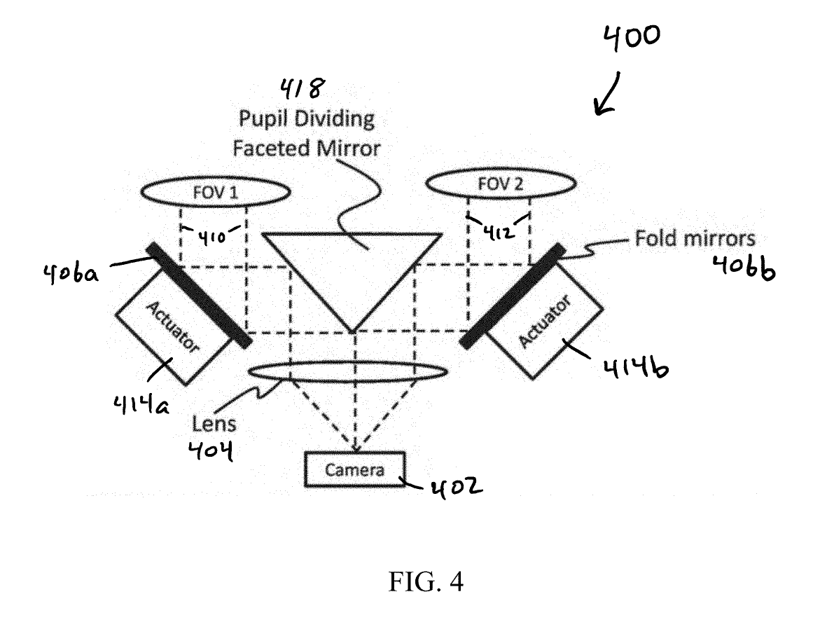

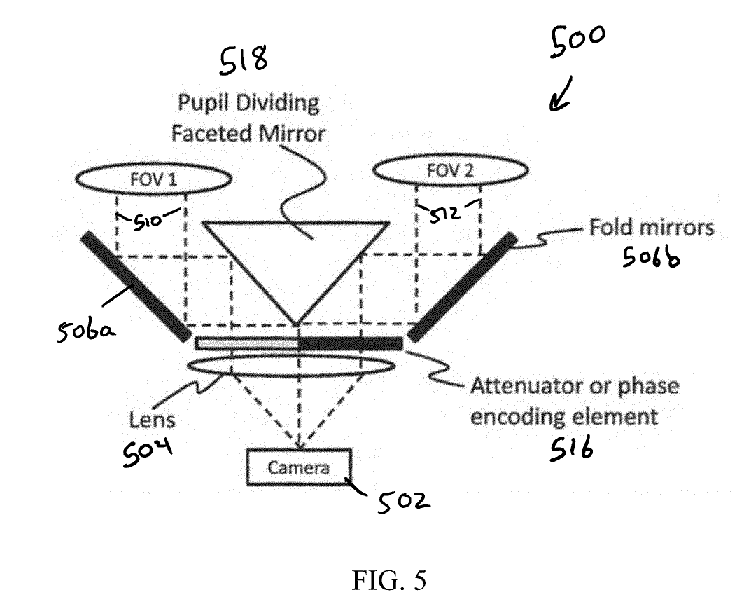

FIGS. 2-3 illustrate a full aperture optical design architecture in which the transmission function of the aperture is divided amongst the plurality of channels (e.g., intensity, wavelength, polarization states, etc. can all be divided in various manners). The devices and methods described herein can also be applied to systems that employ sub-aperture multiplexing architectures, such as those disclosed in U.S. patent application Ser. No. 14/668,214, which is incorporated by reference above. In sub-aperture multiplexing systems, the aperture area is divided amongst the plurality of channels. FIGS. 4-5 illustrate two such embodiments of an optically multiplexed imaging system according to the teachings of the present disclosure. More particularly, FIG. 4 illustrates an optically multiplexed imaging system 400 in which two channels are multiplexed to image two fields of view (FOV 1 and FOV 2), though more channels could also be included. The system 400 includes a camera 402 with image sensor or array, a lens 404 (which can include any number of optical elements to gather and focus light), first and second fold mirrors 406a, 406b to reflect light (410, 412) from the fields of view onto a multiplexing assembly 418. The multiplexing assembly 418 can have a variety of forms but, in the illustrated embodiment, is a pupil dividing faceted mirror. The shape of the mirror can multiplex, or combine, the light incident on each facet thereof and reflect it toward the lens 404 and camera 402. The shape of the mirror and its facets can be configured to maximize the available pupil area for each channel or portion of the field of view being imaged. Further details on pupil dividing faceted mirrors can be found in U.S. patent application Ser. No. 14/668,214, which is incorporated by reference above.

In the embodiment shown in FIG. 4, the first and second fold mirrors 406a, 406b can be coupled to first and second actuators 414a, 414b, respectively. The actuators 414a, 414b can be similar to the actuator 214 described above, and can be configured to rapidly and precisely adjust the position of the mirrors 414a, 414b via any combination of, e.g., tilting, translating, rotating, etc. The system 500 shown in FIG. 5 is similar to the system 400 of FIG. 4, but includes first and second (and possibly other) fold mirrors 506a, 506b that are stationary. Encoding is instead accomplished using an encoding element 516 placed in the light path of one or more channels. The encoding element 516 can be similar to the encoding element 316 and can be, for example, an attenuator or a phase encoding element in certain embodiments.

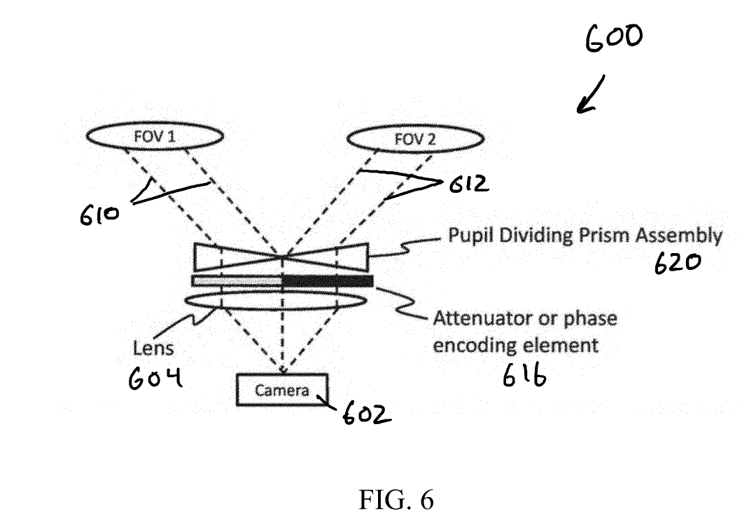

Fold mirrors and pupil dividing faceted mirrors or other reflective elements are not the only possibilities for multiplexing assemblies. FIG. 6, for example, illustrates one embodiment of an optically multiplexed imaging system 600 that includes a multiplexing assembly 620 formed by a pupil dividing prism assembly. The prisms can be used to direct light from different regions of a scene (FOV 1 and FOV 2 in the figure) into sub-aperture regions of an imaging lens 604. The prisms included in the prism assembly 620 can be achromatic to reduce wavelength dispersion. FIG. 6 illustrates the system 600 as including an encoding element 616 that can be an attenuator or a phase encoding element, similar to the encoding element 516 of FIG. 5. Prism-based designs, however, can be utilized in connection with actuators, such as actuators 414 of FIG. 4, instead of an attenuator or other phase encoding element. For example, each prism can be coupled to an actuator and tilted or otherwise moved individually. Alternatively, certain sub-groups of prisms in an assembly can be coupled to an actuator and moved, or the entire prism assembly can be configured to be tilted or otherwise moved as a unit to encode one or more channels of the optically multiplexed imaging system 600.

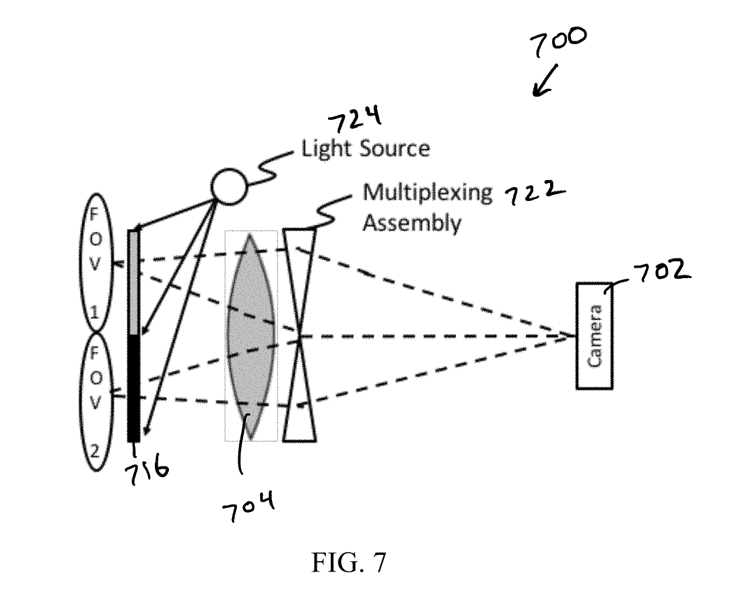

FIG. 7 illustrates still another technique for encoding one or more channels of an optically multiplexed imaging system: active illumination of one or more channels. Similar to the embodiments described above, the optically multiplexed imaging system 700 includes a camera 702 with an image sensor or array, a lens 704 or other optical elements to focus light on the camera 702, and a multiplexing assembly 722. The system 700 also includes a light source 724 that can be configured to illuminate individual channel fields of view or combinations thereof in a known way to encode the multiplexed image. Moreover, the encoding pattern can change as a function of time in a known way. Still further, the system 700 can include a further encoding element 716, such as an attenuator or phase encoding element to work in conjunction with the active illumination from the light source 724. Decoding the multiplexed image captured by the camera 702 in the system 700 can be accomplished by correlating the multiplexed image intensity to the illumination applied by the light source 724 in order to reconstruct the field of view corresponding to each channel.

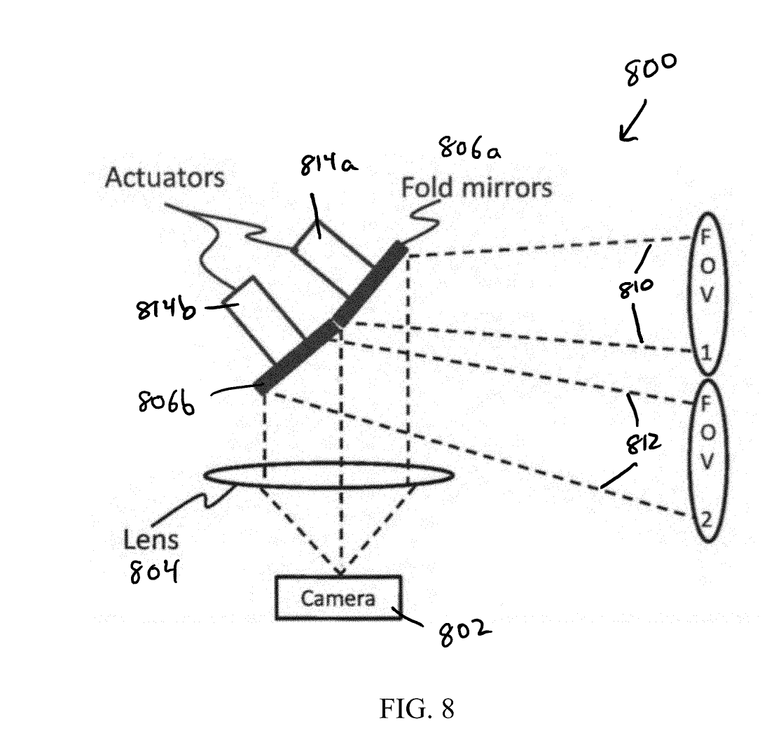

In some embodiments, tiltable or otherwise movable fold mirrors can be utilized to perform sub-aperture multiplexing without a separate multiplexing assembly like the assembly 418 shown in FIG. 4. FIG. 8 illustrates one embodiment of an optically multiplexed system 800 that includes a camera 802 with an image sensor or sensor array and a lens 804 that can include a single optical element (as shown in the figure) or a plurality of optical elements to focus light on the camera 802. The system 800 can also include first and second fold mirrors 806a, 806b that can be coupled to first and second actuators 814a, 814b, respectively, such that the first and second fold mirrors are independently tiltable or otherwise movable. Each fold mirror can correspond to a channel being multiplexed and a field of view (e.g., FOV 1 and FOV 2) being imaged. Each fold mirror can be tilted or otherwise moved to a different position and/or angle by the actuator coupled thereto in order to focus light from the corresponding field of view into the aperture of the imaging lens 804.

In a first embodiment of a method for encoding the multiplexed channels, the actuators 814a, 814b can be configured to rapidly tilt (or otherwise move) and settle the fold mirrors 806a, 806b by a known angle between frames to laterally shift each channel of the multiplexed image. Super-resolution capability can be implemented by further precisely controlling the fold mirrors 806a, 806b to sample multiple angles within a field of view of a single pixel (i.e., to move the fold mirrors to different positions with a precision that is less than an angular sampling of an image sensor pixel). In a second embodiment of a method for encoding the multiplexed channels, the actuators can be configured to rapidly tilt (or otherwise move) the fold mirrors at a frequency faster than a capturing frame rate of the camera 802 to spatially encode the point spread function by motion blur.

Note that in the above-described system 800, as well as other systems described herein, disambiguation can be accomplished even when one channel is not encoded. For example, in the embodiment of FIG. 8, the first fold mirror 806a can be stationary while the second fold mirror 806b can be coupled to the second actuator 814b as shown. In other words, in a system that multiplexes N channels, N−1 channels can be encoded and a single channel can remain unmodified. In some embodiments, however, it can be desirable to encode all channels (e.g., by coupling all fold mirrors to actuators, etc.) as this can enhance the encoding and disambiguation capabilities of the system and it can enable additional features, such as super-resolution capability.

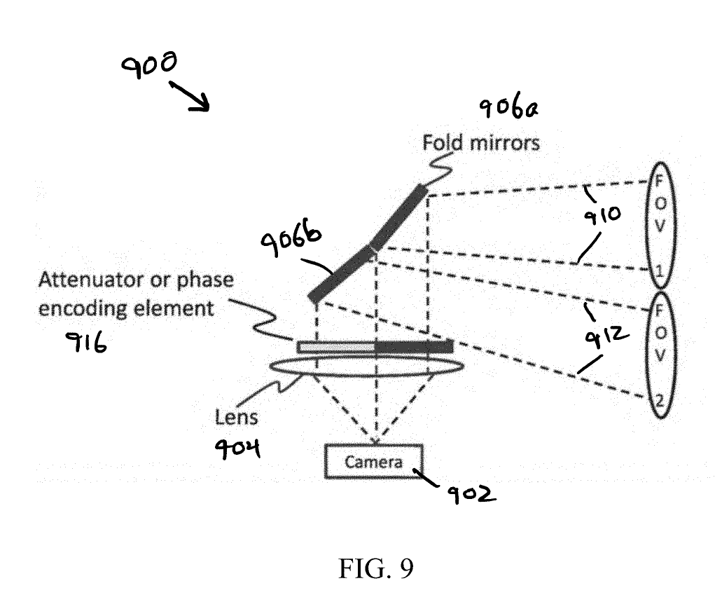

FIG. 9 illustrates an optically multiplexed imaging system 900 that is similar to the system 800 of FIG. 8, but employs a different type of encoding element. More particularly, the first and second fold mirrors 906a, 906b of the system 900 are stationary (and therefore set to reflect light from different regions of a scene toward the lens (or lens system) 904. In addition, there is an encoding element 916 in the light path from the scene to the camera 902. In the illustrated embodiment, the encoding element 916 is disposed between the fold mirrors 906a, 906b and the lens 904.

The encoding element 916 can be, for example, an attenuator or a phase encoding element. In the case of an attenuator, a signal of a sub-set of channels can be modulated by attenuating the signal either partially or fully. A phase encoding element, on the other hand, can spatially encode the point spread function or laterally shift the image in a known manner. In some embodiments, the encoding element 916 can be inserted into a beam path of one or more channels at a frequency related to the frame rate of the camera to encode the one or more channels. This can be accomplished, for example, with an encoding element 916 that rotates about an axis to periodically place different regions of its area in the path of different channels. In other embodiments, the encoding element 916 can be configured to rapidly translate between two or more known positions that place different regions of its area in the path of different channels.

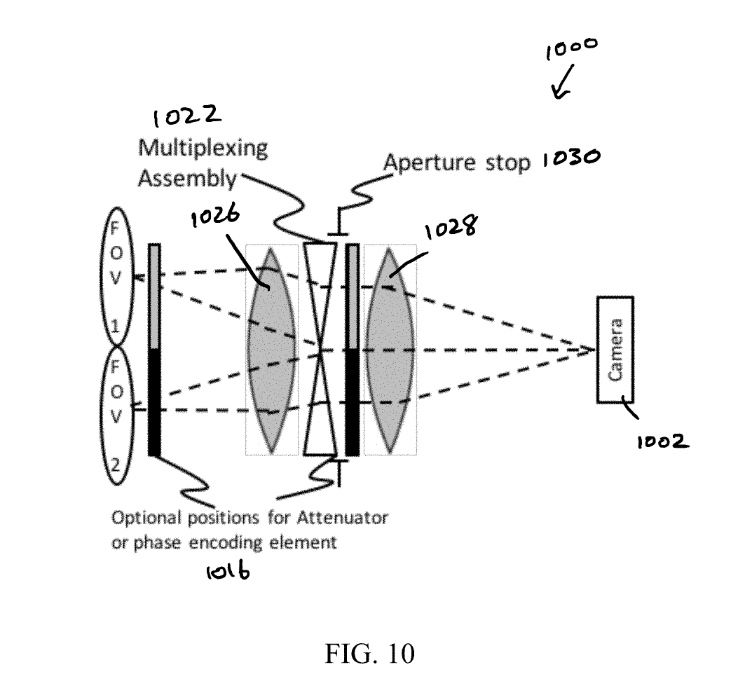

FIGS. 10-27 illustrate still further optical design architectures that can be utilized in connection with the devices and methods described herein. FIG. 10, for example, illustrates a finite-conjugate multiplexed lens group having a fixed effective focal length. The finite conjugate multiplexed lens group can include a first lens (or lens group) 1026 that can collimate light leaving the object plane (i.e., the scene being imaged, shown in the figure as FOV 1 and FOV 2) and a second lens (or lens group) 1028 that focuses the multiplexed fields of view onto the camera 1002. In some embodiments, light can be collimated between the lenses 1026, 1028 and the lenses can be individually aberration corrected. A multiplexing assembly 1022 can be placed between the lenses 1026, 1028 proximate to an aperture stop of the optical system. In such an embodiment, an encoding element 1016 can be placed either proximate to the object plane where the fields of view being imaged are separated, or proximate to the aperture stop where the multiplexing assembly 1022 divides the pupil area. The architecture shown in FIG. 10 can be used in series with other lens groups such that its object or image plane (i.e., where FOV 1 and FOV 2 are shown or where camera 1002 is shown, respectively) can serve as an intermediate focal plane in a larger imaging system.

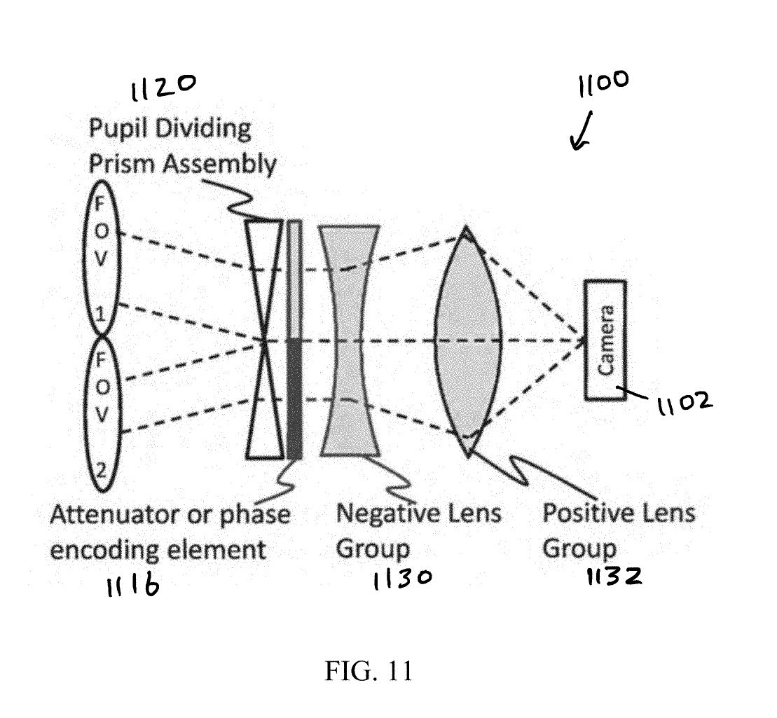

FIG. 11 illustrates another embodiment in which a reverse-telephoto lens design is employed with a remote aperture stop. The system 1100 includes a first, negative lens (or lens group) 1130 closest to the object plane or scene being imaged, as well as a positive lens (or lens group) 1132 closer to the camera 1102. A negative lens is a diverging lens having a negative focal length that causes exiting rays to be more divergent than they were entering the lens. Conversely, a positive lens is a converging lens having a positive focal length that causes exiting rays to be more convergent than they were entering the lens. Note that additional lenses or lens groups can be included to correct field-related aberrations if necessary.

A multiplexing assembly 1120 in the form of a pupil dividing prism assembly can be positioned between the object plane and the negative lens 1130 in some embodiments. Prism elements included in the multiplexing assembly 1120 can include a single prism, a plurality of single prisms, or one or more achromatic prism groups. An encoding element 1116, such as an attenuator or a phase encoding element, can be positioned between the multiplexing assembly 1120 and the negative lens 1130. In many cases, the effective focal length of this optical design can generally be longer than the overall length of the lens. In addition, it can be desirable in such a configuration for the attenuator 1116 and multiplexing assembly 1120 to define a remote aperture stop of the system 1100. The architecture of the system 1100 can be well suited for use with a higher number of multiplexed channels because the reverse-telephoto lens design can be configured to position an aperture stop near the front of the system, a position that can be ideal for placement of a sub-aperture pupil dividing multiplexing assembly. Using a sub-aperture pupil dividing multiplexing assembly can make practical a larger number of multiplexed channels because sub-aperture pupil dividing multiplexing assemblies can be more compact than full aperture systems that include beam splitters and other components. The system 1100 can also be well suited for use with cameras 1102 that operate in the ultraviolet (UV) range, visible-light range, and short-wave infrared (IR) range (about 0.9 μm to about 2.5 μm), as well as the long-wave IR range (about 8 μm to about 14 μm) when using an uncooled microbolometer for an image sensor.

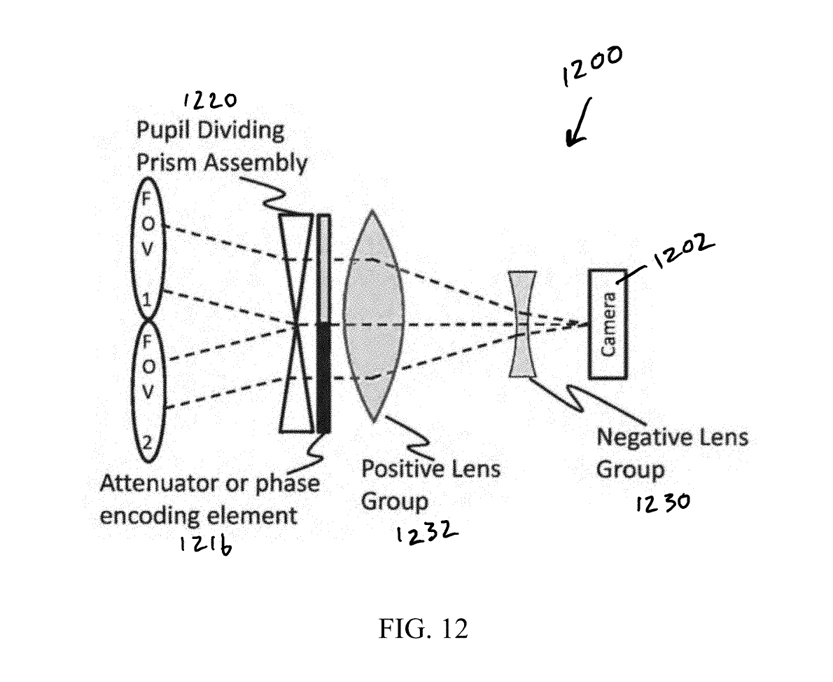

FIG. 12 illustrates an embodiment of an optically multiplexed imaging system 1200 similar to FIG. 11, but with a telephoto lens design. With a telephoto lens design, the positions of the positive lens (or lens group) 1232 and the negative lens (or lens group) 1230 are reversed from the configuration shown in FIG. 11, with the positive lens 1232 positioned closer to the object plane (i.e., FOV 1 and FOV 2 in the figure) and the negative lens 1230 positioned closer to the focal plane (i.e., camera 1202). As with the above-described embodiment, additional lenses to correct field-related aberrations can be included. The effective focal length of the system 1200 can generally be longer than the length of the lens assembly. In addition, it can be desirable in such a configuration for an attenuator or phase encoding element 1216 and a multiplexing assembly 1220 to define a remote aperture stop of the system 1200. In the illustrated embodiment, a pupil dividing prism assembly is utilized as the multiplexing assembly 1220. Prism elements included in the multiplexing assembly 1120 can include a single prism, a plurality of single prisms, or one or more achromatic prism groups. Similar to the embodiment shown in FIG. 11, the system 1200 can be well suited for use with a camera 1202 that operates in the ultraviolet (UV) range, visible-light range, and short-wave infrared (IR) range (about 0.9 μm to about 2.5 μm), as well as the long-wave IR range (about 8 μm to about 14 μm) when using an uncooled microbolometer for an image sensor.

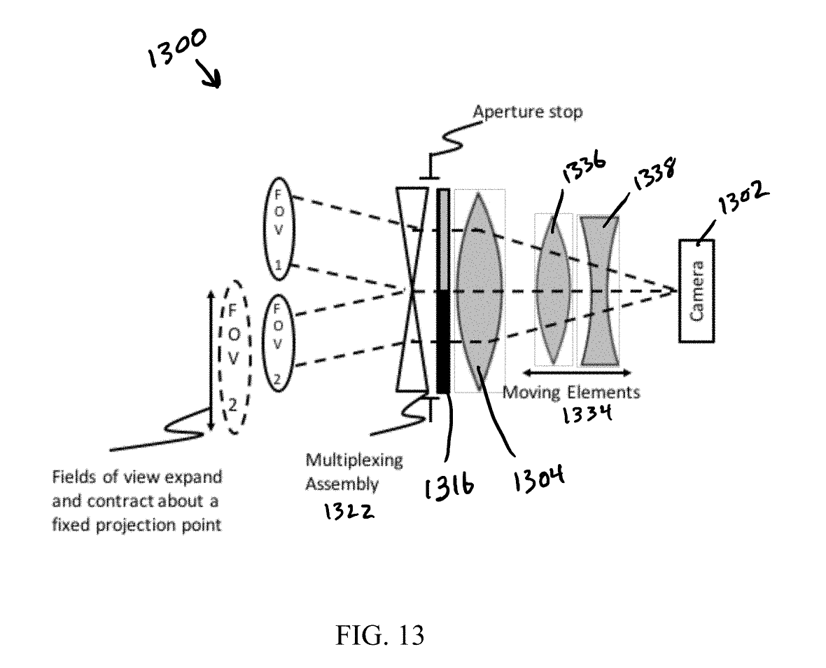

FIGS. 13-15 illustrate embodiments that include movable lens components to create a zoom lens design. FIG. 13, for example, illustrates a system 1300 that includes a camera 1302, lens 1304, attenuator or phase encoding element 1316, and multiplexing assembly 1322 to image two fields of view (FOV 1 and FOV 1), though a different number of fields of view is possible in other embodiments. The system 1300 further includes a zoom lens assembly 1334 that can change its focal length to magnify the fields of view being imaged, e.g., enlarging FOV 2 bounded by a solid line in the figure to FOV2 bounded by a dotted line in the figure. The zoom lens assembly 1334 can include a variety of optical elements but, in one embodiment, can include a positive lens 1336 and a negative lens 1338 that are movable relative to the camera 1302, lens 1304, encoding element 1316, and multiplexing assembly 1322.

In the embodiment shown in FIG. 13, the multiplexing assembly 1322 can be configured to steer light by a fixed angle such that a center of each channel's field of view can remain fixed as the fields of view are magnified. In other words, the variation of the focal length can cause the projection of the center of each channel's field of view in object space to remain fixed. Thus, in the system 1300 a center point of each field of view can remain fixed as the zoom lens moves to change the magnification with which the field of view is imaged.

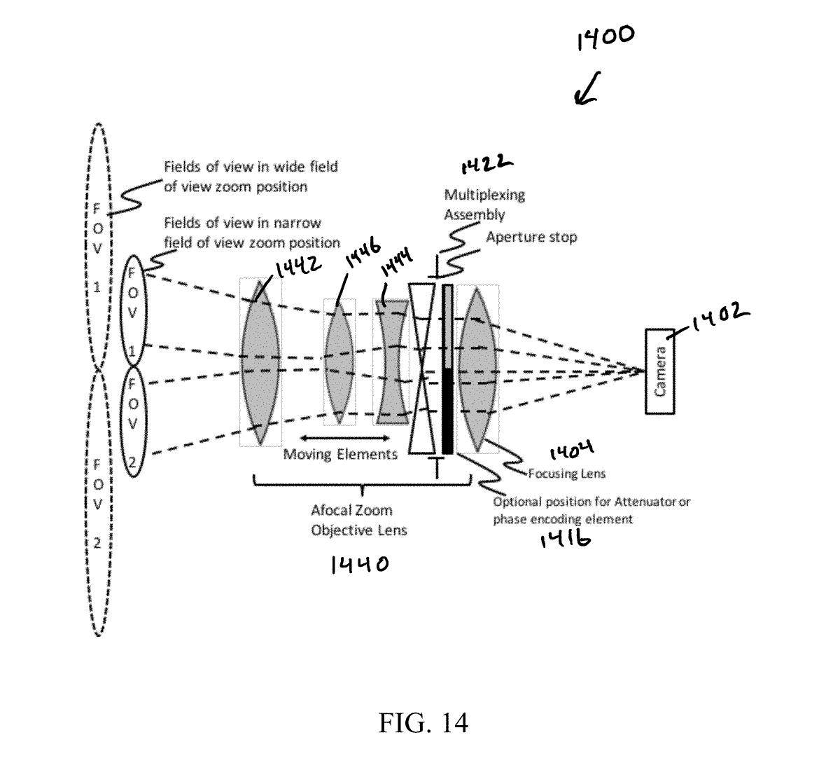

FIG. 14 illustrates an alternative embodiment of a zoom lens in which a variable focal length afocal objective zoom lens directs light to a multiplexing lens group. More particularly, the system 1400 includes a camera 1402, focusing lens (or lens group) 1404, encoding element 1416 (such as an attenuator or phase encoding element), and a multiplexing assembly 1422. Positioned between these elements and the fields of view in object space is an afocal zoom objective lens assembly 1440. An afocal lens design is one that produces no net convergence or divergence of the light rays and therefore has an infinite effective focal length. In the illustrated embodiment, the afocal zoom assembly 1440 can include a first positive lens 1442, a negative lens 1444 positioned closer to the multiplexing assembly 1422, and a second positive lens 1446 positioned between the first positive lens 1442 and the negative lens 1444. The various components of the afocal zoom assembly 1440 can be movable relative to one another and/or movable as a group relative to the other components of the system 1400.

In the system 1400, the multiplexing assembly 1422 can be positioned proximate to an aperture stop of the system and between the afocal zoom assembly 1440 and the focusing lens 1404. As the afocal zoom assembly 1440 moves, or as particular elements within the zoom assembly move, the angular magnification between the object space of the fields of view (FOV 1 and FOV 2 in the figure) and the afocal space between the zoom assembly and focusing lens (or lens group) can change. As a result, the projections of the fields of view being imaged can shift as they are magnified (i.e., a center of each field of view being imaged can shift as the field of view is magnified). For example, the imaged fields of view can change from FOV 1 and FOV 2 bounded by solid lines to FOV 1 and FOV 2 bounded by dotted lines in the figure. Shifting the centers of the fields of view in this manner can maintain a constant relative overlap or separation of the imaged fields of view over the zoom range. This is in contrast to the system 1300 described above, where magnification of the fields of view being imaged can result in an overlapping view at sufficient magnification (e.g., if a magnified FOV 1 was shown in FIG. 13 similar to the FOV 2 bounded by a dotted line, the two fields of view bounded by dotted lines would overlap—this is not true in FIG. 14).

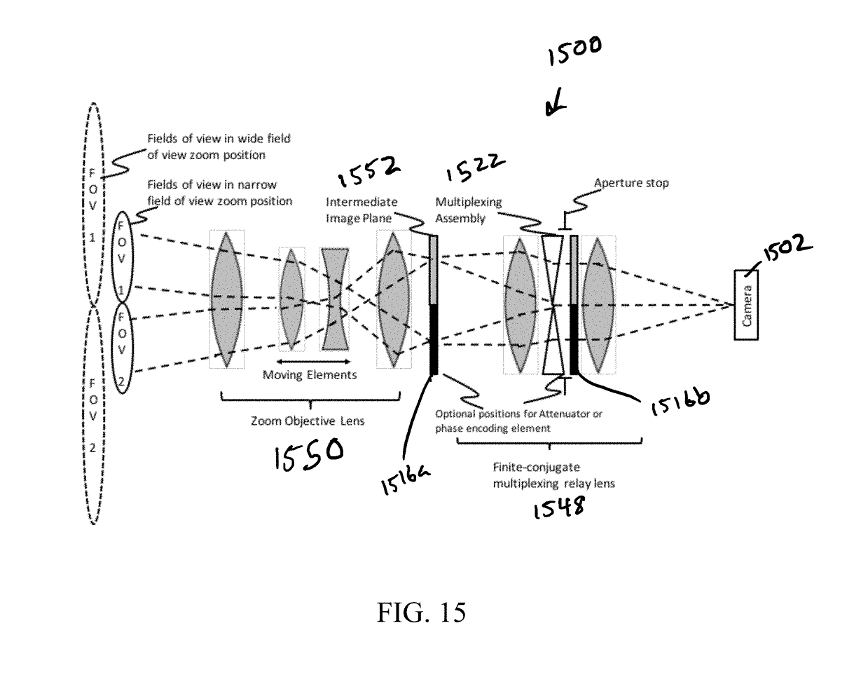

FIG. 15 illustrates still another embodiment of a zoom lens system 1500 in which a variable focal length objective zoom lens forms an intermediate image that is reimaged with a fixed focal length multiplexed lens group. In the illustrated embodiment, the system 1500 includes a camera 1502, a finite-conjugate multiplexing relay lens 1548 that can be similar to the lens design shown in FIG. 10, as well as a zoom objective lens assembly 1550. The zoom assembly 1550 can be similar to the assembly 1440 described above, but can include a focal length that shifts as elements of the zoom lens are moved. The two lens assemblies can be positioned such that the zoom lens assembly 1550 is closer to object space (i.e., FOV 1 and FOV 2 in the figure) and the finite-conjugate lens group 1548 is closer to the focal plane of the camera 1502. The zoom lens assembly 1550 can be configured to create an intermediate image at an intermediate image plane 1552. This intermediate image can be reimaged by the finite-conjugate multiplexing lens assembly 1548 and focused on the image sensor of the camera 1502. As with the system 1400 described above, when elements of the zoom lens assembly 1550 are moved to cause a change in the focal length of the assembly, a magnification of the fields of view focused to the intermediate image plan 1552 can result (e.g., from FOV 1 and FOV 2 bounded by solid lines in the figure to FOV 1 and FOV 2 bounded by dotted lines in the figure). This intermediate image can be multiplexed by the finite-conjugate multiplexing relay lens to overlay FOV 1 and FOV 2 on the image sensor of the camera 1502.

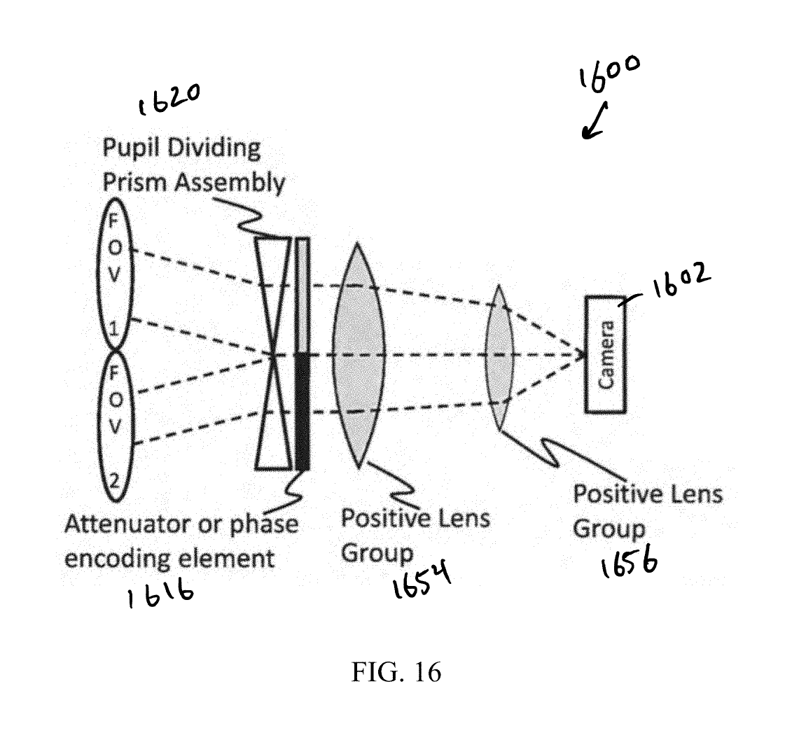

Moving away from zoom lens embodiments, FIG. 16 illustrates a system 1600 that includes a Petzval lens design with a remote aperture stop. The Petzval lens design includes two positive lens groups 1654 and 1658 positioned in front of a camera 1602. The two lens groups define a remote aperture stop between the lens group 1654 that is farthest from the camera 1602. A multiplexing assembly, such as a pupil dividing prism assembly 1620 and an encoding element 1616, such as an attenuator or a phase encoding element, can be positioned proximate to the remote aperture stop. The system 1600 is illustrated with two channels that image two fields of view (FOV 1 and FOV 2), but the system is well suited to handle additional channels because the optical design allows for placement of a sub-aperture pupil dividing multiplexing assembly at an external pupil or aperture stop. As noted above with respect to FIG. 11, sub-aperture pupil dividing multiplexing assemblies can be smaller than full aperture multiplexing assemblies, thereby permitting multiplexing of a high number of channels in a compact design. Similar to other optical designs described above, prism elements included in the multiplexing assembly 1620 can include a single prism, a plurality of single prisms, or one or more achromatic prism groups, and the system 1600 can be well suited for use with a camera 1602 that operates in the ultraviolet (UV) range, visible-light range, and short-wave infrared (IR) range (about 0.9 μm to about 2.5 μm), as well as the long-wave IR range (about 8 μm to about 14 μm) when using an uncooled microbolometer for an image sensor. Moreover, additional lenses can be included to correct field-related aberrations if necessary.

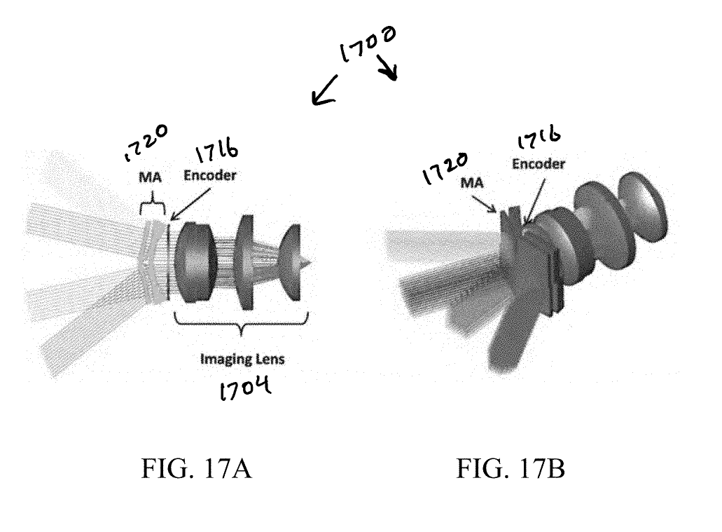

FIGS. 17A and 17B illustrate one embodiment of a system 1700 that employs a sophisticated Petzval lens design with a 4-channel achromatic prism multiplexing assembly 1720. An aperture stop is positioned at (or defined by) an attenuator-based encoder 1716 in front of the imaging lens group 1704. The encoder 1716 can be circular and can be divided into 4 quadrants with at least 1 quadrant having a different transmission (i.e., transparency) than the others. The encoder can be synchronized to the camera and can complete a full rotation in a period of 4 frames. Disambiguation of the multiplexed image can be performed by observing the attenuation magnitude and time sequence of the collected frames.

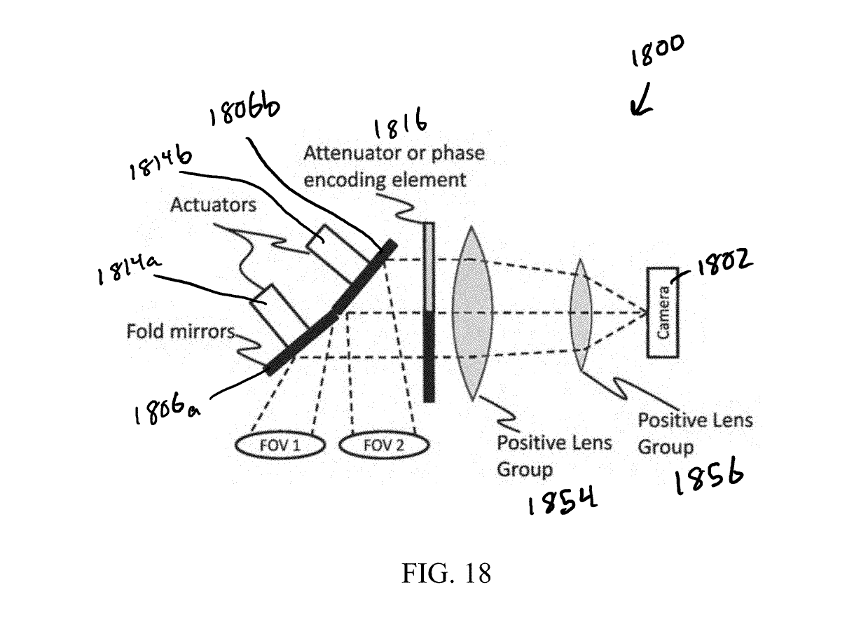

As noted above with respect to FIGS. 8 and 9, any of the optical designs described herein that employ prism-based or other multiplexing assemblies can alternatively be implemented using a multiplexing assembly based on mirrors, be they movable via coupling with actuators or stationary and combined with an encoding element such as an attenuator or phase encoding element. FIG. 18 illustrates one embodiment of a system 1800 making use of a Petzval lens design in combination with tiltable fold mirrors coupled to actuators. Similar to the system 1600 described above, the system 1800 can include a camera 1802, a first positive lens group 1854 and a second positive lens group 1856 disposed between the camera and the first positive lens group. A fold mirror 1804 and associated actuator 1814 can be used to direct light from each field of view being imaged through an attenuator or phase encoding element 1816 to the lens groups 1854, 1856 and camera 1802. In the illustrated embodiment, the two channels, or fields of view being imaged (i.e., FOV 1 and FOV 2) mean the system is illustrated with first and second fold mirrors 1806a, 1806b and associated actuators 1814a, 1814b. Additional channels can be included with additional mirrors and associated actuators.

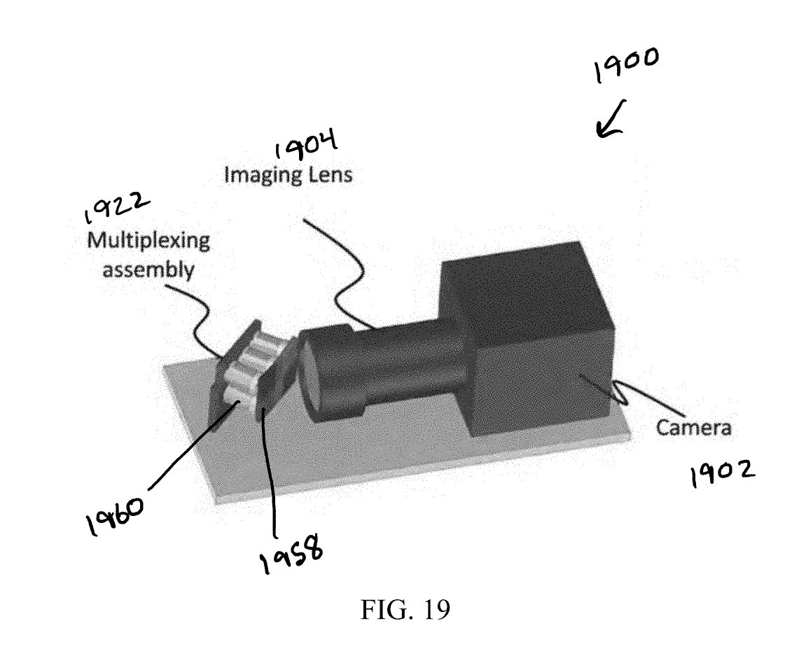

FIG. 19 illustrates one embodiment of an optically multiplexed imaging system 1900 that includes a similar design as the system 1800 but implements additional multiplexed imaging channels. In particular, the system 1900 includes a camera 1902, an imaging lens 1904, and a multiplexing assembly 1922 that includes a light modulating array having 6 individually actuated mirrors 1958 for reflecting light into the imaging lens 1904. Each mirror sits on a piezoelectrically controlled tilt/tip stage 1960 that is capable of stepping and settling faster than the capturing frame rate of the camera 1902. This can allow the multiplexing assembly 1922 to shift one or more channels of the multiplexed image between frames, or to be continuously oscillated to spatially encode the point spread function. Moreover, the precision afforded by the piezoelectrically controlled stages 1960 can allow the mirrors to tilt by angles much smaller than the field of view of a pixel (i.e., a pixel's angular sampling), which can enable super-resolution image reconstruction.

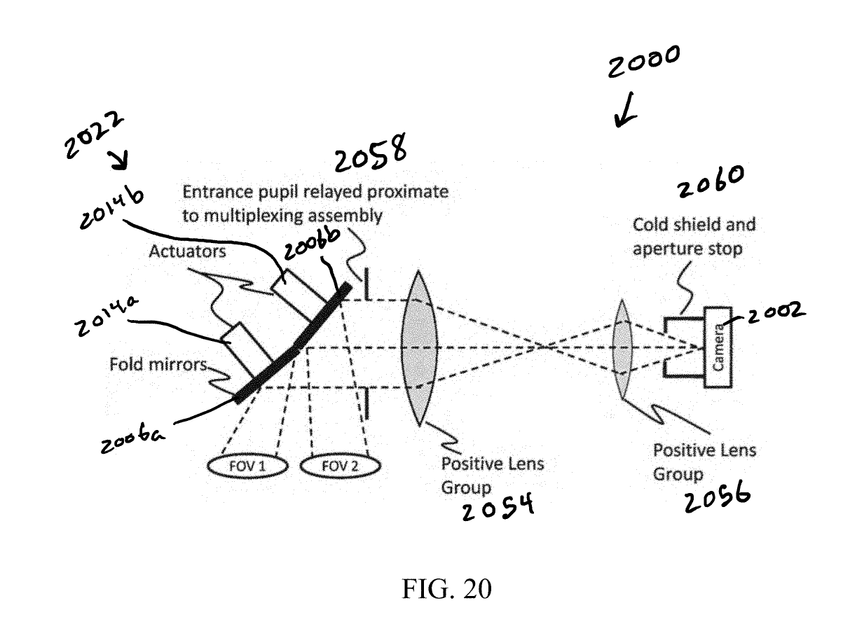

FIG. 20 illustrates still another optical design in which a reimaging pupil relay is employed. In particular, a lens assembly including a first positive lens group 2054 and a second positive lens group 2056 can be configured to create an entrance pupil 2058 that is relayed outward toward object space from the camera 2002 and first and second positive lens groups. A multiplexing assembly 2022 that can include fold mirrors 2006a, 2006b and associated actuators 2014a, 2014b can be positioned proximate to the entrance pupil 2058. The multiplexing assembly 2022 can divide the pupil and encode the various imaging channels (two channels imaging FOV 1 and FOV 2 are shown, though the design is suited for use with additional channels) with a high degree of multiplexing uniformity. The system 2000 also adds very little thermal background emission, which can make it suited for use with mid-wave infrared (about 3 μm to about 5 μm) and long-wave infrared (about 8 μm to about 14 μm) camera sensors. In some embodiments, the camera 2002 can include a cold shield and aperture stop 2060 to cool the detector. Such embodiments can benefit from a relay lens design that projects the cooled aperture stop to a location proximate the multiplexing assembly. While mentioned in connection with mid- and long-wave infrared cameras, the design can also be suited to use with ultraviolet, visible-light, and short-wave infrared (IR) (about 0.9 μm to about 2.5 μm) sensors, as a relay design can often reduce the size of optical elements associated with these detectors.

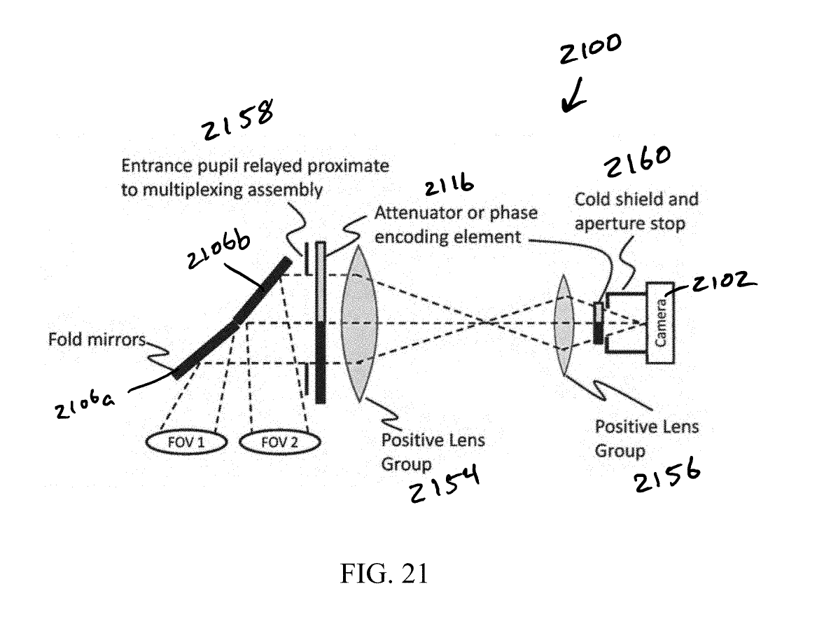

FIG. 21 illustrates an alternative embodiment of the above-described pupil relay system that employs fixed reflective elements 2106a, 2106b and a separate encoding element 2116 instead of an array of movable mirrors with associated actuators. In particular, the system 2100 includes an encoding element 2116, such as an attenuator or a phase encoding element, that can be placed either proximate to the relayed entrance pupil 2158 or proximate to the cold shield and aperture stop 2160 at the camera 2102. The encoding element 2116 can be considered to be internal to the system 2100 if placed at the latter position—or any position between a powered optic (such as a lens or mirror) and the image plane of the camera 2102. Performing multiplexed channel encoding at an internal position can be advantageous in certain embodiments because, for example, the environment inside the cold shield 2160 can be utilized to aid in encoding via attenuation, as described in more detail below.

In an embodiment utilizing a mid-wave infrared (about 3 μm to about 5 μm) or long-wave infrared (about 8 μm to about 14 μm) image sensor with a cooled detector, an encoding narcissus shield can be utilized to attenuate one or more channels. Narcissus is a change in image detection resulting from radiation reflected from lens surfaces back onto the image sensor or detector. A Narcissus shield can prevent such radiation from reaching the image sensor.

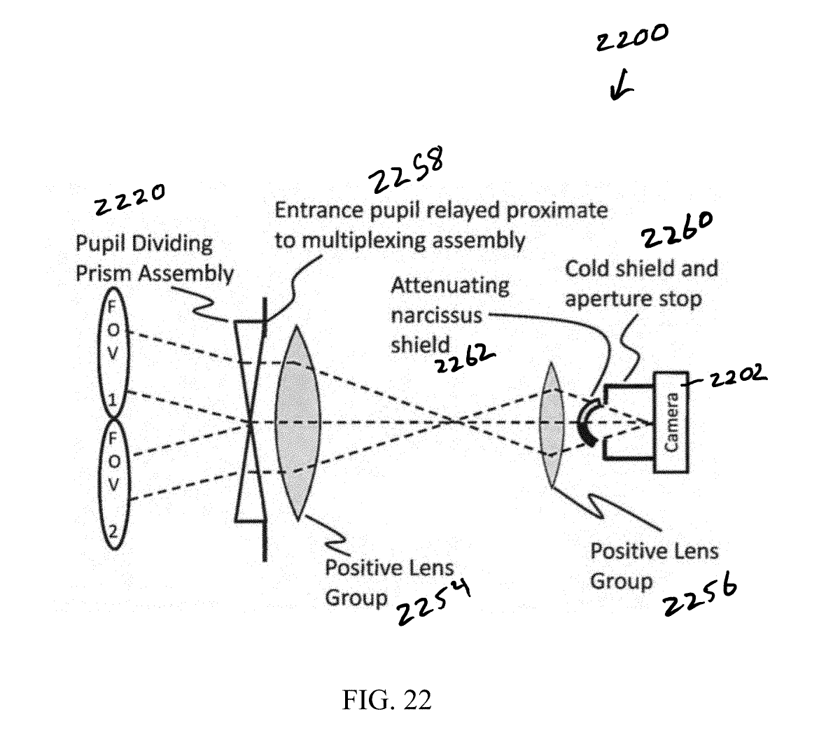

FIG. 22 illustrates one embodiment of a system 2200 that employs a narcissus shield 2262 as an attenuator to encode multiplexed channels. The system can include a camera 2202 having a cold shield and aperture stop 2260. The narcissus shield 2262 can be placed proximate the aperture stop 2260 and collect light traveling from object space (i.e., FOV 1 and FOV 2 in the figure) through a pupil dividing prism-based multiplexing assembly 2220, a first positive lens group 2254, and a second positive lens group 2256. The multiplexing assembly 2220 can be positioned proximate to an entrance pupil 2258 of the system 2200. While a prism-based multiplexing assembly 2220 is illustrated, other embodiments of a multiplexed assembly as described herein can also be employed.

The attenuating narcissus shield 2262 can have a concave surface facing towards the camera 2202, as well as partially or fully reflective sections that are pupil matched with the pupil dividing elements in the multiplexing assembly. These attenuating reflective sections can act as narcissus shields (also known as warm shields or warm stops). From the perspective of the cooled detector in the camera 2202, the attenuating reflective sections of the narcissus shield 2262 can appear to have a low temperature because they reflect light from the cold space (within the cold shield 2260) back to the image sensor or detector of the camera. This design can allow a detector sensitive to thermal background radiation to utilize attenuation-based temporal encoding without increased thermal background. Because encoding is performed inside the lens assembly a compact prism-based (or larger mirror-based) multiplexing assembly can be utilized at the relayed entrance pupil. The narcissus shield 2262 can be configured to rotate about an axis at a frequency related to the capturing frame rate of the camera 2202 to place regions with different attenuation characteristics into the beam path of different channels. Alternatively, multiple narcissus shields can be placed on a moving structure that periodically places shields within different attenuation patterns into the beam path to encode a plurality of imaging channels.

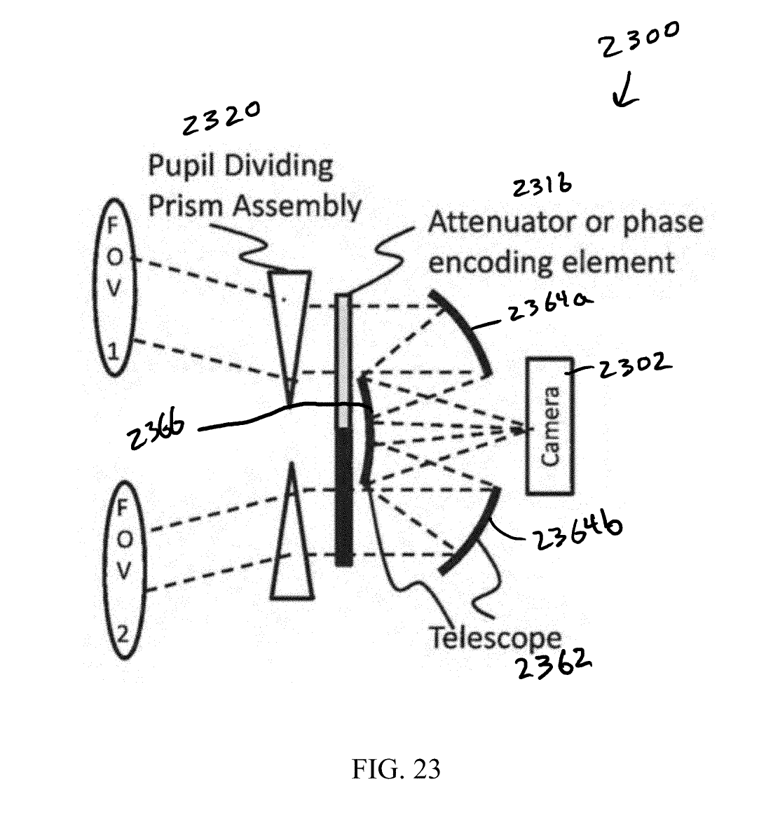

FIGS. 23-27 illustrate various embodiments of optically multiplexed imaging systems that include reflective telescope designs. Such systems can employ an encoding element, such as an attenuator or a phase encoding element, similar to the embodiments described above. Reflective systems (i.e., those that channel light via reflection off one or more surfaces) surfaces can often have a smaller field of view than refractive systems (i.e., those that channel light through one or more lenses). This can simplify design of a multiplexing assembly because field-dependent multiplexing errors, such as multiplexing non-uniformities and anamorphic distortion from prisms, can be reduced.

FIG. 23 illustrates one embodiment of a system 2300 utilizing a two channel, two-mirror telescope design. In particular, the system 2300 can include a camera 2302, a multiplexing assembly 2320, such as a pupil dividing prism-based multiplexing assembly, and an encoding element 2316, such as an attenuator or a phase encoding element. Light collected from the first and second fields of view (FOV 1 and FOV 2, respectively) can pass through the multiplexing assembly 2320 and encoding element 2316, then it can be reflected by the two-mirror telescope 2362 and focused on the camera 2302. More particularly, light from a first field of view FOV 1 can be reflected off a first mirror 2364a toward a second mirror 2366, and off the second mirror toward the camera 2302. Light captured from a second field of view FOV 2 can follow a similar path reflecting off a first mirror 2364b and the second mirror 2366. Accordingly, the telescope is referred to as a “two-mirror” design because light from each channel reflects off two mirrors as it passes through to the camera 2302.

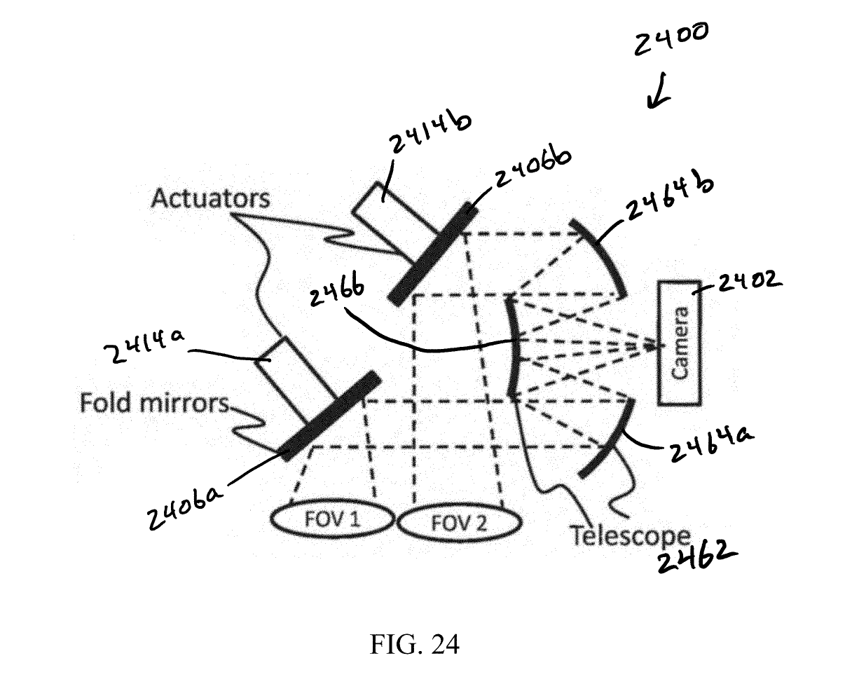

FIG. 24 illustrates an alternative embodiment of a reflective telescope system 2400 that employs movable fold mirrors in place of a prism-based multiplexing assembly. More particularly, the system 2400 can include a camera 2402, telescope 2462, and first and second fold mirrors 2406a, 2406b coupled to first and second actuators 2414a, 2414b to channel light from first and second fields of view (FOV 1 and FOV 2) to the camera. The design of the two-mirror telescope 2462 can be similar to the above-described telescope 2362, and light delivered to the first mirrors 2462a, 2462b can be reflected off the first and second fold mirrors 2406a, 2406b that are being rapidly and precisely tipped, tilted, or otherwise moved to encode the various multiplexed channels. While only two channels are shown imaging two fields of view, the number of channels and associated fields of view can be changed by including additional fold mirrors with actuators and telescope components. Of note with the system 2400 is that it operates entirely by reflection of light, which makes it capable of simultaneously transmitting ultraviolet through long-wave infrared wavelengths.

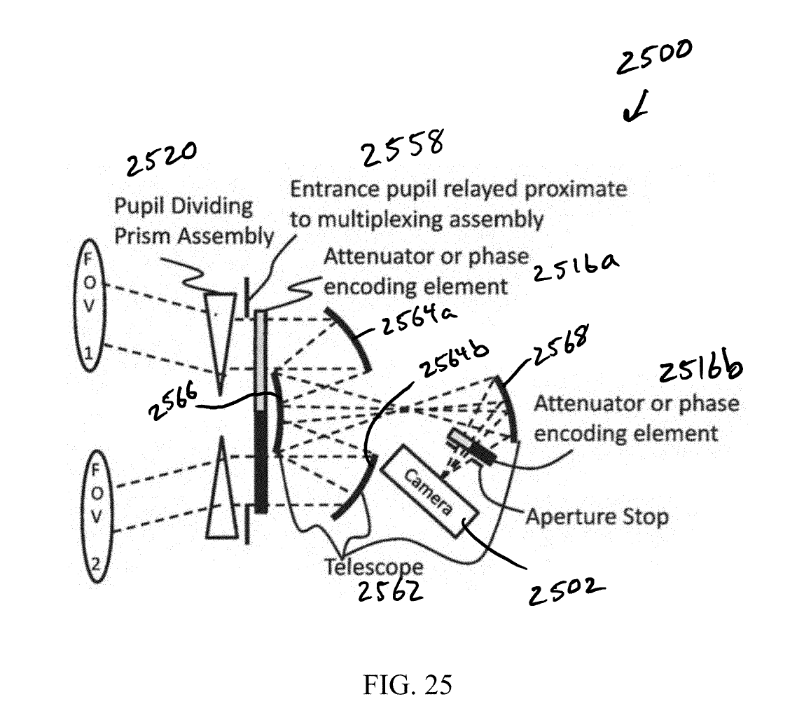

FIG. 25 illustrates one embodiment of a system 2500 that includes a three mirror telescope design. The three mirror telescope 2562 reflects light from each channel off a first mirror 2564, a second mirror 2566, and a third mirror 2568 to focus it on the camera 2502. The three-mirror telescope design relays an internal stop or entrance pupil 2558 to a remotely located multiplexing assembly 2520, such as a pupil dividing prism-based multiplexing assembly. An encoding element can be positioned proximate to the multiplexing assembly, as shown by encoding element 2516a, or proximate to an aperture stop of the camera 2502, as shown by encoding element 2516b. The encoding element 2516 can be an attenuator or a phase encoding element, as described herein. In embodiments placing the encoding element 2516 at an aperture stop of the camera 2502, a narcissus shield can be utilized as an attenuator for infrared image detectors, as described above.

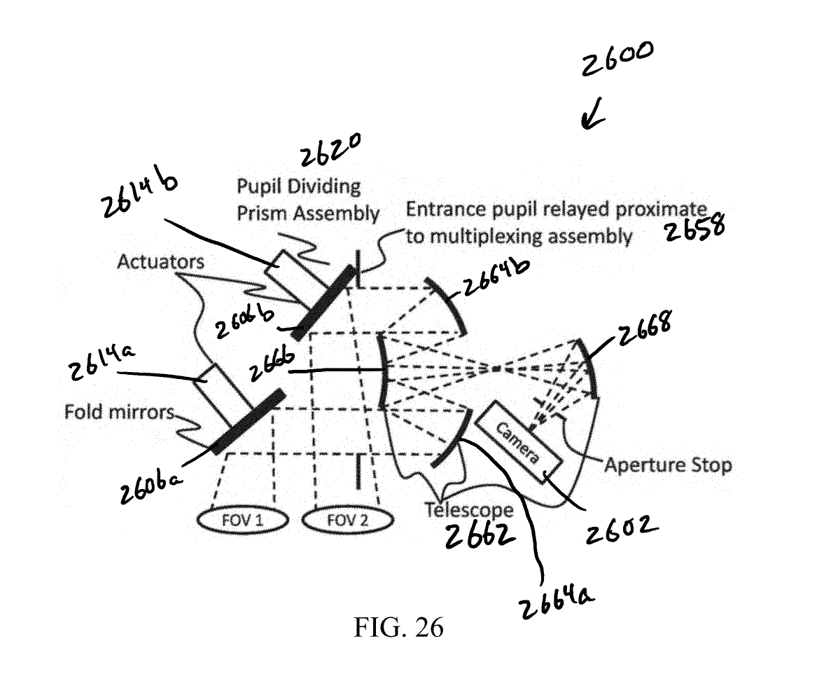

FIG. 26 illustrates another embodiment of a system 2600 utilizing a three-mirror telescope design in combination with movable mirrors and actuators to accomplish rapid and precise multiplexed channel encoding. In particular, first and second fold mirrors 2606a, 2606b that are coupled to actuators 2614a, 2614b (e.g., piezoelectrically controlled actuators) can be utilized to collect light from different fields of view (FOV 1 and FOV 2 in the figure) and direct it into the three-mirror telescope 2662 that focuses the light onto the camera 2602. The fold mirrors 2606a, 2606b can be positioned proximate to an entrance pupil 2658 relayed from the camera 2602 by the reflective telescope design. As with the above-described embodiments, while only two multiplexed imaging channels (imaging FOV 1 and FOV 2) are shown, any number of multiplexed channels is possible.

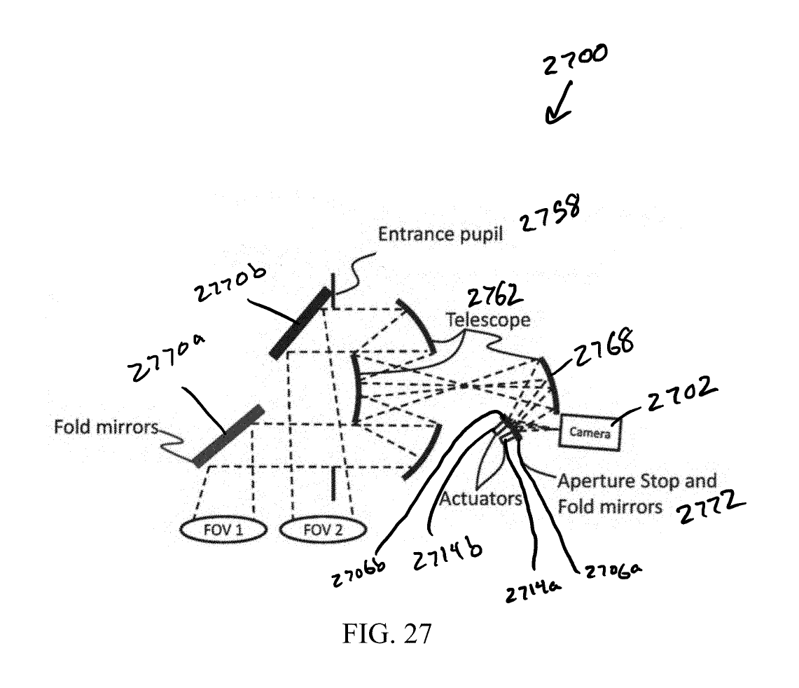

FIG. 27 illustrates still another embodiment of a three-mirror telescope system 2700 wherein encoding is performed between the telescope 2762 and the camera 2702. More particularly, first and second stationary fold mirrors 2770a, 2770b are positioned proximate to a relayed entrance pupil 2758 of the system 2700 to reflect light from the plurality of fields of view being observed (i.e., FOV 1 and FOV 2 in the figure, though additional channels/observed fields of view are possible). Light reflected from the stationary mirrors 2770a, 2770b is channeled through the three-mirror telescope 2762, but in contrast the above-described embodiments the third mirror 2768 does not reflect light directly onto the camera 2702. Instead, the third mirror 2768 reflects light onto a light modulating array, such as an array of movable fold mirrors 2706a, 2706b and associated actuators 2714a, 2714b. This array encodes the light from each channels and reflects it onto the image sensor of the camera 2702. The light modulating array can be positioned at an aperture stop 2772 of the camera 2702. Using an array of actuated fold mirrors inside of the imaging system 2700 can be applied to many types of reimaging reflective optical designs, including 3- and 4-mirror image telescopes and spectrometers. Furthermore, an alternative embodiment of the system 2700 can replace the stationary fold mirrors 2770a, 2770b with a multiplexing assembly as described above, including, for example, an assembly including prisms or achromatic prisms.

The above-described embodiments of optically multiplexed systems include a number of optical designs that can be used to implement the teachings of the present disclosure. As a summary and with reference to the embodiment of FIG. 4 (though the various other embodiments described herein can achieve similar performance), an optically multiplexed imaging system 400 can achieve rapid and precise dynamic encoding using movable mirrors 406a, 406b mounted on piezoelectric tip-tilt stages or other actuators 414a, 414b. By reflecting light onto a reflective multiplexing assembly 418 placed near the entrance pupil of a large-aperture lens 404, multiple fields of view can be overlaid onto a focal plane array (FPA) of a camera 402. Each mirror 406a, 406b can be mounted on the piezoelectric tip-tilt stage or other actuator 414a, 414b and these actuators can be configured to move faster than a capturing frame rate of the camera 402 (i.e., rapid and dynamic movement) with tip-tilt precision that is finer than an angular sampling of each pixel in the camera image sensor or focal plane array (i.e., precise movement). Such an embodiment can include all of the attributes outlined above, for example, a) the piezoelectric or other actuators can be rapidly controlled in different oscillation and/or step-stare patterns to dynamically optimize the encoding, b) object detection in sparse scenes can be made ideally signal-efficient and robust through optimized point spread function engineering, c) the piezoelectric or other actuators can provide rapid 2-dimensional field of view shifting for dense scene reconstruction at video frame rates, d) the piezoelectric or other actuators can provide sub-pixel dithering capability for super-resolved image reconstruction, e) the piezoelectric or other actuators can be rapidly scanned faster than the camera's integration time for temporally super-resolved imagery, and f) the piezoelectric or other actuators can be controlled to produce sequence shifts which lead to computationally efficient image reconstruction, as described in more detail below. Note that while this summary is provided with respect to the pupil-dividing reflective multiplexing assembly and piezoelectric-based actuators shown in FIG. 4, any of the other architectures described herein—and others appreciated by a person of skill in the art—can achieve these same capabilities and are considered within the scope of the present disclosure.

In computational imaging, the cost of image reconstruction can be significant without carefully choosing encoding and decoding methods that pair to provide efficiency, especially when the image being reconstructed is large. The devices and methods described herein can include techniques for encoding multiplexed images and paired decoding methods that enable more efficient image reconstruction/disambiguation. As an example, consider a four-megapixel focal plane multiplexed six times. Using six frames to reconstruct this image can require a solution of a system of 24 million equations, with 24 million unknowns. A direct matrix inversion is computationally expensive, even after taking into account matrix sparsity and the inherent parallelism of this task. To reduce this computational burden, one embodiment of a paired method for encoding and disambiguating a multiplexed image can include shifting the image of one channel in each frame by an integer number of pixels in order to encode the multiplexed image. In such an embodiment, a difference can be taken between two multiplexed frames, which would leave only the moving channel, as the signal from all other channels would drop out. Decoding this channel can require only an appropriately chosen cumulative row and/or column sum of the difference frame, a task that is far more computational efficient than solving or all of the channels simultaneously.

In another embodiment of paired encoding and decoding/disambiguation methods for multiplexed imaging, a similar approach can be taken with respect to amplitude modulation. By way of example, an optically multiplexed imaging system can be configured to rapidly temporally encode each channel at a unique temporal frequency. Such encoding can include, for example, continuously shifting the image back and forth at a different rate for each channel or otherwise inducing a high frequency channel-dependent periodic variation in the image by means of rapid defocus, point spread function (PSF) engineering, or attenuation. Using this approach, each channel can be encoded at a separate frequency. Decoding the image can be achieved by decomposing each pixel's time series by frequency and reading off the image of each channel from its corresponding frequency bin. Such an approach has an advantage in that is can be implemented using a standard focal plane and off-board data analysis components. In other embodiments, the decoding can be performed on-chip with an advanced focal plane with in-pixel frequency discrimination to simultaneously disambiguate N channels at the full frame rate of the camera.

Still another embodiment of a method for encoding image channels in an optically multiplexed imaging system can include attenuating, shifting, and/or defocusing or otherwise point spread function encoding the image at each channel by a known, distinct frequency, and performing a computationally efficient reconstruction via a frequency analysis of the time series for each pixel of the image sensor or other detector. In some embodiments, such a method can include attenuating, shifting, defocusing or otherwise point spread function encoding the image at each channel by a known function of time, thereby measuring the channel images using a matrix with positive, bounded entries. Reconstruction methods that can be paired with such encoding methods can include recovering each channel image from the time series measured in each pixel using a matrix inverse.

A number of variations on the above-described method are possible. For example, in certain embodiments, the above-mentioned function of time for attenuating the image at each channel can include turning each channel on and off at a specific frequency per channel. In such an embodiment, the image reconstruction method can include computationally projecting each pixel's time series onto the corresponding channel frequencies. In other embodiments, the matrix inverse can be carried out within the logic of the pixel of each detector element. This can be accomplished, for example, by having counters that project the measured light onto the rows of the inverse matrix.

In still other embodiments, the above-described channel attenuator can include a light modulating array, such as a micro-electromechanical (MEMS) mirror array, and two focal planes can be used to measure two distinct time series per pixel. The two time series correspond to the two directions that light can be reflected off the MEMS mirror array or other light modulating array. A difference between the two measured time series can be utilized to instantiate a matrix with bounded entries that can be either positive or negative. This matrix can be computationally inverted to recover the images corresponding to each channel.

Another embodiment of a method for encoding and decoding multiplexed image channels can include spatially shifting all but one of the channel during a single integration period to blur the images of those channels. This can enable the image of the single stationary channel to be viewed on a blurry background that can be removed using known techniques.

Still another embodiment of a method for encoding and decoding multiplexed image channels can include continuously shifting all channels along different trajectories and shifting the charge or digital measurements on a focal plane array or other image sensor to follow one of the trajectories. This method can recover a single channel's image on a blurry background. A focal plane array or image sensor capable of multiple simultaneous measurement shifts could simultaneously acquire all images, each on a blurry background.

A still further embodiment of a method for encoding and decoding multiplexed image channels can include differentially rotating each channel's field of view such that image sensor motion can cause each channel's image to move in a different direction on a focal plane. An image sensor of focal plane array capable of charge shifting or digital measurement shifting could recover a channel's image on a blurry background by shifting measurements or charge in the direction along that channel's motion. Again, a focal plane array or other image sensor capable of of multiple simultaneous measurement shifts could simultaneously acquire all images, each on a blurry background.

As noted above, the devices and methods described herein for dynamically variable encoding of channels in an optically multiplexed imaging system can provide a number of advantages, including the ability to operate in a plurality of distinct sensing modes. For example, one such operating mode can be an object detection mode, which is optimized to detect unresolved objects in a sparsely populated scene. A sparsely populated scene is one that includes low levels of objects and background information. Sparse scenes can be intrinsically sparse (e.g., a star-scape) or may be sparse in a given representation (e.g., a time-lapse sequence may be temporally sparse in that the scene does not change much over time, making changes more easily identifiable). Accordingly, an object detection mode can be well suited for use with, for example, start tracking for attitude control and celestial navigation, astronomical observation, and targeting/tracking for surveillance or defense applications.

In an object detection mode, a number of pixels in the focal plane can exceed the number of objects in the scene. An optically multiplexed imager can therefore trade the pixel surplus to simultaneously measure multiple fields of view by uniquely spatially encoding the point spread function of each field of view. The dynamic variation in encoding described herein can allow the encoding to be activated, deactivated, and/or dynamically varied to optimize the sensor for signal collection and/or disambiguation. For example, the point spread function can be encoded to emphasize maximum signal-to-noise ratio for detection and tracking by concentrating light in a single pixel, or alternatively to emphasize maximum frame rate sparse scene disambiguation by channel-specific signal blurring. Furthermore, the ability to rapidly and precisely shift multiplexed channel images to provide for spatial super-resolution and/or to rapidly and precisely modulate multiplex channel images to provide for temporal super-resolution can allow the system to perform enhanced background reduction. If the background has higher spatial or temporal frequencies than the conventional sampling resolution of the camera, these frequencies can alias to cause spurious detections that can be suppressed with super-resolution techniques.

A second operating mode that can be interchangeably switched to using the devices and methods described herein is an imaging mode in which an extended rich scene can be observed and each image sensor pixel can view multiple relevant object points. Such an operating mode can be suited to, for example, use in commercially available cameras for still and motion imagery. In this mode, deterministic disambiguation of the image can require the optically multiplexed sensor to conduct a number of scene measurements equal to the number of channels (e.g., capture 4 frames for a 4-channel system). With conventional cameras the tradeoff is that snapshot imagery may not be possible with a multiplexed imager, however, this is unnecessary in many situations because most modem image sensors can collect a required number of samples at rates much faster than those required for motion imagery. In this operating mode, the dynamically variable rapid and precise encoding methods described herein can allow the encoding to be optimized as a function of frame rate for robust disambiguation of specific spatial frequencies and to achieve spatial and/or temporal super-resolution. The encoding can also be varied to change the computational requirements of image reconstruction and to take advantage of in-pixel computational capabilities of advanced focal plane arrays, as described above. When using an advanced camera with in-pixel frequency discrimination, rapid high frequency encoding can allow all N scene measurements to be conducted simultaneously, thereby producing so-called snapshot imagery in an optically multiplexed imaging device.

The devices, systems, and methods described herein can include repeatedly interchanging between operating in a plurality of imaging modes, such as the above-described object detection mode and imaging mode. Movement from one operating mode to another can be accomplished in a variety of manners. For example, in some embodiments variation in encoding can occur based on information gathered in the imaging system and can occur at a rate slower than the frame rate of the camera. By way of further example, in some embodiments a system operating in object detection mode can switch to imaging mode when activity is detected, such that the activity is captured with higher resolution, etc. In other embodiments, movement from one operating mode to another can occur in response to receiving a command, e.g., a command from a user to focus on a particular area or resume observing a large sparse area, etc.

Systems having the ability to operate in distinct imaging modes and to repeatedly switch between operating modes by dynamically varying multiplexed image channel encoding can have a number of applications. As noted above, systems operating in an object detection mode can have numerous applications in observational astronomy, for attitude control, and for targeting and tracking in defense applications. There are also a number of security applications that require surveillance of a large perimeter that could use systems operating in an object detection mode for motion tracking. Optically multiplexed imaging systems can be particularly suited to these applications because they can provide an extended field of view, improved resolution, dynamically tunable encoding for performance optimization, and opportunities for spatial and temporal super-resolution.

Applications for optically multiplexed imaging systems operating in the above-described imaging mode are also numerous. The ability to provide increased field of view and resolution is universally desirable in the camera market. Optically multiplexed imaging systems of the type described herein can be applied to many areas, including commercial photography, security and surveillance, and scientific imaging. Systems of the type described herein can thrive in applications where image sensors have a high cost per pixel due to the fact that a reduced number of sensors are utilized to image an extended field of view. Exemplary applications can include using photon counting detectors for low-light imaging, optical communication and active imaging (e.g. LIDAR, 3D LADAR or super-resolved imaging with structured illumination), and using infrared focal planes for surveillance, tracking, microscopy, spectroscopy, and in bio-medical applications.

Additionally, a novel characteristic of optically multiplexed imaging systems can be the ability to image a scene that has a continuous or discontinuous field of view with a different aspect ratio than the focal plane array. One example of this is an elongated field of view panoramic video camera. Another exemplary application can be a surveillance camera that can simultaneously look in multiple directions, such as down two hallways or around two sides of a building. Another exemplary application can be creating a multiplexed field of view configuration to efficiently translate from one aspect ratio to another. For example, a common 5:4 aspect ratio of infrared cameras can be converted to a popular 16:9 high definition format display by multiplexing the 5:4 image sensor in a 3×2 or 4×3 configuration. By way of further example, an efficient 2-channel multiplexing of a 1024×1024 camera image sensor could closely match the resolution of ubiquitous 1080p displays (1920×1080). For many uses, such infrared security cameras, this resolution and field of view increase can be invaluable.

Still another application area is stereo-vision or 3D imaging. This is an increasingly important field for robotic navigation, 3D entertainment, and virtual reality. For use in such environments, an optically multiplexed imaging system can be configured to observe the same scene form a different perspective, rather than increasing a field of view by observing different regions of a scene. The parallax between images can be used to passively detect object range. Conventional methods of doing this can lose resolution because images must be spatially separated on the focal plane rather than multiplexed to take advantage of the full resolution of the focal plane array or other image sensor.

Such systems can be well suited to use with advanced focal plane arrays that include on-chip processing capabilities. There is natural synergy when increases in computational demands for optically multiplexed imaging can be compensated for by capabilities of the focal plane array or other image sensor. For example, decreased signal and contrast that can be caused by aperture division and well-sharing can be compensated for by increased bit-depth and integration time. By way of further example, post-processing for image de-multiplexing can be performed on-chip to alleviate down-stream electronics requirements, and in-pixel frequency discrimination can be used for snapshot de-multiplexing, as described above.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

1. A method of imaging a scene, comprising:
capturing light from a plurality of regions of the scene in a plurality of channels;
directing each of the plurality of channels onto a focal plane of an image sensor; and
encoding an image formed by one or more of the plurality of channels prior to detection by the image sensor;
wherein encoding of the image is varied by a precise amount over time.

2. The method of claim 1, wherein encoding the image includes shifting the image.

3. The method of claim 2, wherein shifting the image is performed with a precision that is less than an angular sampling of an image sensor pixel.

4. The method of claim 2, wherein shifting the image is performed at rates equal to, or faster than, a capturing frame rate of the image sensor.

5. The method of claim 2, wherein a magnitude of image shift used to encode the image is varied over time.

6. The method of claim 5, wherein variations in the magnitude of image shift occur at rates equal to, or greater than, a capturing frame rate of the image sensor.

7. The method of claim 2, wherein a direction of image shift used to encode the image is varied over time.

8. The method of claim 7, wherein variations in the direction of image shift occur at rates equal to, or greater than, a capturing frame rate of the image sensor.

9. The method of claim 2, wherein a time delay between shifting the image is varied over time.

10. The method of claim 2, wherein shifting the image is accomplished by tilting a mirror using an actuator.

11. The method of claim 10, wherein the actuator is piezoelectric.

12. The method of claim 1, wherein encoding the image includes applying an engineered point spread function; and
wherein a spatial structure of the engineered point spread function is varied over time.

13. The method of claim 1, wherein encoding the image includes at least partially attenuating the image; and
wherein any of a duration and an extent of the at least partial attenuation is varied over time.

14. The method of claim 13, wherein attenuating the image includes placing a partially transparent attenuator in a light path of the channel being encoded.

15. The method of claim 13, wherein attenuating the image includes placing a fully absorbing attenuator in a light path of the channel being encoded.

16. The method of claim 13, wherein attenuating the image includes rotating an attenuating element about an axis to place different regions of its area into a light path of the channel being encoded.

17. The method of claim 1, wherein encoding the image includes imparting illumination to the channel being encoded to amplify a signal thereof relative to other channels.

18. The method of claim 1, wherein encoding the image includes modifying a phase of the image by imparting any of an aberration and a diffraction effect into a wavefront moving through the channel being encoded.

19. The method of claim 18, wherein modifying the phase of the image includes placing a wedged optical element into a light path of the channel being encoded.

20. The method of claim 18, wherein modifying the phase of the image includes placing a non-plano surface into a light path of the channel being encoded.

21. The method of claim 1, wherein encoding the image is performed using a micro-electromechanical system (MEMS) light modulating array.

22. The method of claim 1, wherein encoding the image includes deforming a mirror.

23. The method of claim 1, wherein the image formed by one or more of the plurality of channels is encoded using at least two different techniques.

24. The method of claim 23, wherein the at least two different techniques include modifying a phase of the image and attenuating the image.

25. The method of claim 24, wherein modifying the phase of the image includes any of shifting the image and applying an engineered point spread function to the image.

26. A method of imaging a scene, comprising:
capturing light from a plurality of regions of the scene in a plurality of channels;
directing each of the plurality of channels onto a focal plane of an image sensor;
capturing a frame from the image sensor containing all of the images formed by the plurality of channels in a first state;
modifying an image formed by at least one of the plurality of channels to a second state;
capturing a frame from the image sensor containing all of the images formed by the plurality of channels in the second state;
repeating the steps of modifying an image formed by at least one of the plurality of channels and capturing a frame from the image sensor for each of a plurality of predetermined states.

27. The method of claim 26, further comprising repeatedly cycling through the plurality of predetermined states.

28. The method of claim 26, wherein the plurality of predetermined states includes two states and an image formed by at least one of the plurality of channels oscillates between the two states in time with a capturing frame rate of the image sensor.

29. The method of claim 26, wherein the plurality of predetermined states follow a predetermined pattern.

30. The method of claim 26, wherein the plurality of predetermined states are any of random and non-repeating.

31. The method of claim 26, wherein modifying the image includes shifting the image by a magnitude equal to, or greater than, one pixel at the focal plane.

32. The method of claim 31, wherein shifting the image occurs at a rate equal to, or greater than, a capturing frame rate of the image sensor.

33. The method of claim 26, wherein modifying the image includes at least partially attenuating the image.

34. The method of claim 26, wherein modifying the image includes applying an engineered point spread function to the image.

35. A method of imaging a scene, comprising:
capturing light from a plurality of regions of the scene in a plurality of channels;
directing each of the plurality of channels onto a focal plane of an image sensor; and
encoding an image formed by one or more of the plurality of channels prior to capture by the image sensor; and
decoding the image formed by one or more of the plurality of channels using an algorithm paired to the encoding method.

36. The method of claim 35, wherein encoding the image includes spatially shifting the image.

37. The method of claim 36, wherein the image is spatially shifted by an integer amount of pixels.

38. The method of claim 36, wherein the image is spatially shifted per frame captured by the image sensor.

39. The method of claim 38, wherein decoding the image includes taking differences between sequential frames to yield a spatial derivative of the image along a direction of motion.

40. The method of claim 35, wherein encoding the image includes attenuating one of the plurality of channels per frame captured by the image sensor.

41. The method of claim 35, wherein encoding the image includes spatially shifting an image formed by each of the plurality of channels using a predetermined unique frequency; and
wherein decoding the image includes conducting a frequency analysis of a time series for each pixel of the image sensor.

42. The method of claim 35, wherein encoding the image includes any of defocusing and point spread function encoding an image formed by each of the plurality of channels using a predetermined unique frequency; and
wherein decoding the image includes conducting a frequency analysis of a time series for each pixel in the image sensor.

43. The method of claim 35, wherein encoding the image includes attenuating an image formed by each of the plurality of channels using a predetermined function of time such that the image can be measured using a matrix with positive, bounded entries; and
wherein decoding the image includes measuring a time series for each pixel of the image sensor and constructing the image with a matrix inverse.

44. The method of claim 43, wherein the predetermined function of time any of activates and deactivates each of the plurality of channels at a unique frequency; and
wherein decoding the image includes computationally projecting the time series of each pixel of the image sensor onto a corresponding channel frequency.

45. The method of claim 43, wherein the matrix inverse is performed within logic of each pixel of the image sensor.

46. The method of claim 45, wherein performing the matrix inverse includes projecting measured light onto rows of an inverse matrix using logic that implements a dot product.

47. The method of claim 43, wherein attenuating an image formed by each of the plurality of channels includes reflecting light off a light modulating array and measuring a distinct time series per pixel at two different focal planes, each time series corresponding to two directions light could be reflected from the array; and
wherein decoding the image includes taking a difference between the time series in order to instantiate a matrix with bounded entries that are any of negative and positive.

48. The method of claim 47, further comprising computationally inverting the matrix with bounded entries to recover the image formed by one of the plurality of channels.

49. The method of claim 47, wherein the light modulating array is a micro-electromechanical (MEMS) mirror array.

50. The method of claim 35, wherein encoding the image includes spatially shifting all but one of the plurality of channels during a single integration period to blur images created by all but one of the plurality of channels; and
wherein decoding the image includes removing the one channel not spatially shifted from the blurred background of the other channels.

51. The method of claim 35, wherein encoding the image includes continuously shifting each of the plurality of channels along different trajectories; and
wherein decoding the image includes shifting any of a charge and a digital measurement of the image sensor to follow a trajectory of the channel being decoded, thereby allowing the image to be removed from a blurred background of other channels.

52. The method of claim 51, further comprising simultaneously decoding images formed by a plurality of channels by simultaneously shifting any of a charge and a digital measurement of the image sensor along a plurality of trajectories used to shift images formed by the plurality of channels.

53. The method of claim 35, wherein encoding the image includes differentially rotating each of the plurality of channels so that an image formed by each channel moves in a different direction on the focal plane of the image sensor; and
wherein decoding the image includes shifting any of a charge and a digital measurement of the image sensor to follow a direction of the channel being decoded, thereby allowing the image to be removed from a blurred background of other channels.

54. The method of claim 53, further comprising simultaneously decoding images from a plurality of channels by simultaneously shifting any of a charge and a digital measurement of the image sensor along a plurality of directions used to rotate images formed by the plurality of channels.

55.-109. (canceled)
